(19) United States
(12) Patent Application Publication
(10) Pub. No.: US 2006/0101047 A1
(43) Pub. Date: May 11, 2006

(54) Method and system for fortifying software

(76) Inventor: John R. Rice, West Lafayette, IN (US)

Correspondence Address: Intellectual Property Group;Bose McKinney & Evans LLP, 2700 First Indiana Plaza, 135 North Pennsylvania Street, Indianapolis, IN, 46204, US

(21) Appl. No.: 11/192,886

(22) Filed: Jul. 29, 2005

Related U.S. Application Data
(60) Provisional application No. 60/592,039, filed on Jul. 29, 2004.

(51) Int. Cl. G06F 7/00

(52) U.S. Cl. 707/101

(57) ABSTRACT

A method of developing fortified software using external guards, identifying information, security policies and obfuscation. External guards protect protected programs within the fortified software that they are not part of. The external guards can read and check the protected programs directly to detect tampering or can exchange information with the protected programs through arguments of call statements or bulleting boards. External guards can read instructions and check empty space of the protected program before, during or after it executes, and can check for changes in the variables of the protected program when it is not executing, to more effectively detect viruses and other malware. The identification information can be stored in lists or generated dynamically and registered between the relevant programs for identification purposes during execution.

### RELATED APPLICATIONS

This application claims the benefit of U.S. Provisional Application Ser. No. 60/592,039, filed Jul. 29, 2004.

### TECHNICAL FIELD OF INVENTION

This invention relates to the protection of software systems, and in particular to the technology to protect the integrity and usage of software systems and associated devices.

### BACKGROUND AND SUMMARY OF THE INVENTION

Software fortification allows software systems to control their functionality, their usage and their integrity. The two principal attacks on software integrity are tampering and spoofing. Tampering involves changing the codes, data, authorizations or relationships in the software system. Spoofing involves replacing a software component for a program with an imposter. Fortification can use up to four different methods to protect the software. The first is that all the programs are tamper-proofed by networks of internal and external guards, including separate guard programs. The second is that all system components have secure identities for positive dynamic identification. The third is that components of the system protect each other as well as themselves, and some of the components may be entirely devoted to that protection. The fourth is explicit policies that determine the fortification and establish the system relationships. The software system preferably operates within a secure environment and infrastructure. When the original code is correct, the hardware performs properly, the external authorizations and identifications are reliable. Fortification provides stronger security than just tamper-proofing all system components because it also protects against viruses and dynamic attacks.

A software system is a set of computational components that interact to perform one or more tasks. The system components can include programs, procedures, devices and data that communicate through transfers of control and exchanges of data. The software system may include components which are: a) software within a simple computer with a processor and associated memory; or b) software distributed within a complex computer with multiple processors, operating systems and associated memories; or c) physical devices within little or no software, such as a device with hard wired computations, or d) objects including people and instruments that produce data for and interact with other components; or e) any combination of the above components. The software system may be packaged in a single physical device or distributed among a network of various devices. The logical and physical structure including hardware and networking configuration, is assumed to be fixed during the operation of a software system. The components of the system are completely defined and fortification implements detailed policies to provide protection. Fortification is used to preserve the integrity and functionality of the system, and to control the usage of the system. Fortification also provides some, often very substantial, capabilities to prevent extraction of software subsets from the system and to protect the data of the system.

Fortification creates an integrated, coordinated protection of the system. The system is a completely defined set of software components plus interfaces to external devices or objects. These external devices or objects may be other software modules, hardware, people or anything that interfaces with the system. The system may include components whose only purpose is to protect other components. Fortification of an operational system can include adding protection inside and outside to create a fortified system. Fortification includes the option for some components to be not trusted. Unless a system is fairly simple, it is better to develop the system and its fortification together. The fortification of a system uses detailed knowledge of that system that may enlarge the system substantially to create a fortified version thereof.

Fortification is achieved using four (4) technologies:
Tamperp-Proofing. Inserting internal and external guards to prevent changes in the fortified software.
   Internal guards are code within a single program that check the code and data for correctness or acceptability.
   External guards are code outside of the program or distributed over several components of the fortified system that prevent tampering by checking the program code for correctness or acceptability.
Identification. Providing secure identification of all components of the fortified system and objects interfacing with the fortified system.
Interacting Protections. The various fortified software components protect the original code, each other and themselves. Some components might be entirely devoted to protecting other components of the fortified software.
Systematic Protection Policies. These policies define and control how the protections interact and behave.
   A single guard or component may protect many other components of a fortified system. It might be a hybrid guard doing internal checking of the component, and external checking of other components. The code of a single guard may be distributed over several components of the fortified system. The principal restriction on external guards is that a guard in one component cannot make checks about the state of a second component if it does not know the state of the second component in any given moment.

A related patent application, U.S. patent application Ser. No. 11/178,710, filed Jul. 11, 2005, entitled “Combination Guard Technology for Tamper-Proofing Software,” is hereby incorporated by reference, and describes various types of guards, obfuscation techniques and special protections. Many of the guards described can be used for both external and internal guarding. The different obfuscation techniques can be used for both internal and external guards as well. And the special protection techniques, which are neither purely guards nor purely obfuscations, are also useful for tamper-proofing software.

The technology of internal guarding has matured rapidly in the past few years, and provides versatile and powerful tools to create and insert internal guards into a program. These guards can be very dynamic and continually check the program during its execution. If a program is tampered with, then the correctness tests detect the tampering and the appropriate responses are taken.

External guarding is somewhat more primitive in status. The security products in current use include Tripwire and Vormetrics. The Tripwire process computes a complete checksum of a program once a day and compares that with the correct value. This is normally done on very large sets of programs simultaneously. Vormetrics computes a complete checksum of a program as it is loaded from secondary memory, for example from a hard drive, to primary memory and compares that with the checksum from the last time the program was loaded. It is not difficult to tamper with the program to circumvent such protections. Advancing the technology of external guards is one of the objects of the fortified software technology.

Software fortification uses a definition of the structure of the fortified system and checks it thoroughly and often. One of the ways of accomplishing this is by making positive, secure identifications of the software components, computers, devices, people, and other entities that interact with the system. Identification methodology is highly developed and can be made very secure. Software fortification has higher efficiency requirements than usual in identification, and a secure identification technology is disclosed which provides both high efficiency and high security. Note that this higher efficiency is required because an external guard may execute every millisecond or every microsecond in some applications.

Additional features and advantages of the present invention will be evident from the following description of the drawings and exemplary embodiments.

### BRIEF DESCRIPTION OF THE DRAWINGS

FIGS. 1A and 1B show program instructions before and after inserting arguments for use by external guards, respectively;

FIG. 2 shows an external guard using disguised values;

FIG. 3 shows piggybacking arguments on a call statement for use by an external guard and using disguised values;

FIG. 4 shows an external guard using disguised values with a bulletin board;

FIGS. 5A and 5B show programs passing signatures to verify identity of calling program;

FIG. 6 shows a method of creating signatures using random number generators;

FIG. 7 shows an alternative method of creating signatures using random number generators;

FIGS. 8A-C show an example of preserving privacy through use of signatures;

FIG. 9 is a diagram of a secure personal identification system using a biometric measurement device and a computer;

FIG. 10 provides some examples of system policies and possible responses in the context of an airport check-in system;

FIG. 11 is an outline for a systematic method of designing fortified software;

FIG. 12 is a diagram of an airline passenger management process for use at flight-time check-in;

FIG. 13 is a diagram of an airline counter check-in system and its internal interfaces;

FIG. 14 is a diagram of a voting site process for use on election day;

FIG. 15 shows the use of multiple identification information; and

FIGS. 16A-E show an example of hiding and protecting data with the use of silent and non-silent guards.

### DETAILED DESCRIPTION OF THE PREFERRED EMBODIMENTS

A software system is a set of computer programs that interact to perform a set of tasks. The components of a fortified software system can include programs, procedures, data, people and other items that communicate through transfers of control and exchanges of data. The components may be distributed within a simple machine, a complex machine or a network. The machine might be a general purpose programmable computer, a single purpose fixed program device, or anything in between.

A fortified system has three relevant elements: (a) the original codes of all of its programs; (b) the external interfaces of the system; and (c) the hardware that supports the software execution. The original code is the fortified software before it is fortified or protected from attacks. Hardware may execute programs, so we will distinguish between software and hardware by the assumption that the operation of the hardware is fixed and unchangeable over the lifetime of the fortified system. We consider the hardware security by verifying its identity. The code within fortified software may be changed somehow and we protect against such changes through security measures. The external interfaces handle the input data to, and the output from, the fortified software as specified in the original code. This data can originate from a person, be provided by a device, or be provided by a program that is not part of the fortified software. Of particular interest for security is identification and authorization data for the system. These data consist of things like passwords, fingerprint images, hardware serial numbers, and similar identifiers.

The fortified software is a complete software system if its execution only interacts with other software through its external interface. Of special concern for security are the low level software support modules that are incorporated into the system as a convenience. This is an easy point to introduce malware into a system or to launch attacks on a system.

We assume fortified software has a secure infrastructure, including the hardware, networks, communication and other systems. This means the fortified software is complete, and its elements perform properly. We also assume there are no bugs or malware in the original software.

There are five goals of software security, and fortification primarily focuses on the first two of these. The first goal is to preserve the integrity and functionality of the system by preventing changes to a software component or substitution by unauthorized components. This is called fraud protection or tamper-proofing. The second goal is to control the use of the system by preventing unauthorized entities (people, software or devices) from using the software. This is called piracy protection. The third goal is to prevent extraction of software subsets by preventing the extraction of code, software subsets or methods from the fortified software. This is called fragmentation protection. The fourth goal is the protection of system data by preventing system data from being provided to unauthorized entities. This data could be one number (e.g., a password or key) or a huge file (e.g., a book, a chapter or a song). Note that software subsets are things that are executable code while system data do not execute. This is called media protection. The fifth goal is to protect the intellectual property of the fortified software by preventing anyone from understanding or extracting the process, methods or algorithms in the fortified software. This is called intellectual property or IP protection or reverse engineering protection.

The general goal of software system fortification is to preserve the integrity and functionality of the system, and to control the use of the system that operates in a secure infrastructure. Fortification also provides substantial help when preventing extraction of software subsets, protecting system data, and protecting the intellectual property of the software. Fortification is achieved through the use of four technologies: tamper-proofing, secure identification, interacting protections and systematic policy enforcement. All of the programs are protected from tampering by a network of internal and external guards. Fortification uses both internal guards which protect code inside the software component and external guards which also provide tamper-proofing for code outside the guard's component. These can be located both in other system components and within independent guard programs. These can protect and prevent viruses from infecting fortified software and prevent dynamic attacks on its components. Secure identification is used so that all system components can be positively identified throughout the operation of the system. This is required to secure the interfaces and to prevent spoofing. Interacting protections enable the various components to protect themselves and each other as well as the programs. Some components may be devoted entirely to protection. Systematic policy enforcement is performed using a policy system that is installed during the fortification process. The policy system controls external communication, the relationships among the system components, and the checking and protection procedures used.

The fortification process assumes that the original codes are secure, that is (1) the hardware infrastructure operates properly; (2) the interfaces are correct and complete; and (3) the original software is complete and correct.

The fortification process has three components. The first component is tamper-proofing the system codes. This means that either the code cannot be changed because physical barriers prevent access to the code involved or, more likely, any change in the code will be detected and an appropriate protective response taken. Example responses would be to terminate the computations, notify various external systems or people, or repair the changed code. The responses made are dependent on the nature of the system and its environment.

The second component is to provide secure positive identification of components. When one component of a system contacts another, there are mechanisms to provide positive identification. These identities can have high complexity such as natural biometrics. These identities may also present different appearances each time to prevent spoofing. There may be several exchanges of information in the identification process to make it reasonably efficient to generate these appearances.

The third component is to embed security policies in the system. The security policy system is the central entity for managing the security, identity, and authorizations of the system. It applies both to the particular application and to the general software security. Security policies have two parts: generic system protection measures to be used; and policies about who, how and when authorizations are made or modified.

Tamper-proofing is a technology that uses networks of guards to protect the code of the program from change. The guards systematically and continually check the program's code and each other to see if any changes have been made. If a change is detected, then an appropriate response is made. This technology is described more fully in U.S. patent application Ser. No. 11/178,710, entitled “Combination Guard Technology for Tamper-Proofing Software” which is incorporated herein by reference. Software fortification can be viewed in part as extending this technology to software systems.

Some obfuscation is required in tamper-proofing to protect the guards. If an attacker can identify all the guards exactly, then they can delete them simultaneously and break the protection. The selection of several obfuscation techniques plus specialized guards makes it more difficult to find and remove the guards. This protection can be made stronger and stronger by applying more and more iterations of obfuscation. Special protection techniques are similar to obfuscations in that they preserve the protection of the guards even though they do not necessarily preserve the semantics of the program.

Encryption is a special form of obfuscation for data. The capabilities of encryption are well understood and there are many very strong encryption algorithms. Encryption is very good at hiding information but unfortunately the information must be decrypted before it can be used. Once decrypted, the information is vulnerable to theft or change. Thus, encryption is most suitable for hiding constants within software and for exchanging information over networks.

There are a variety of other security tools that can be used to achieve some of the secure infrastructure goals. The assumption of a secure infrastructure is difficult to achieve. Perhaps the most difficult part of this assumption is that the original code is error-free, which suggests that absolutely secure software systems are very difficult to achieve. The following are some of the supporting tools that can be used to achieve some of the secure infrastructure goals. Malware checkers to check for the presence of varieties of code in a program that can undermine security. These tools can be quite effective for detecting trap doors, spyware, and key loggers. They should be applied to or included in the original code of the components going into the fortified software system. Disc ram transfer monitors are specialized programs to monitor and protect the communications internal to computers. External communication monitors examine the items and patterns of communication to detect and/or combat the various kinds of attacks, for example, denial of service or spyware. Firewalls examine the communication coming into a fortified software system and filter out various classes of communication and content which might be destructive or unwanted. Intrusion detection tools examine the behavior of a system and its communication to detect attempts to insert malware, viruses, spyware, and other unwanted software into the system. Machine and person identification tools help authenticate the identity of machines and people that attempt to access the system. These can include simple password checks, multiple biometrics, or sophisticated challenge response exchanges. Fortification uses a specialized set of identification tools for systems that have distributed components and to be sure that an entire subsystem has not been replaced.

One of the key components of fortification are guards that continuously check the system for attacks, changes and problems. These guards are networked together so that they guard each other and they are integrated into the fortified software so that they are very difficult to identify accurately and cannot be removed without detection. Networks of internal and external guards are inserted into individual programs so that any tampering is detected. This technology is the foundation of the fortification process and it generates the basis of fortification.

Internal guards check observed data against required data. The comparisons can be for equality, normal for integer and symbolic information, or close enough for numerically measured data such as biometrics or for the results of floating point computations. The definition of “close enough” is specified in the policy system. Machine codes are normally checked by computing a hash checksum of the machine instructions interpreted as integers. One of the tasks in guarding code is to be able to identify exactly which machine words are instructions that must not be changed. Guards and devices are usually in simpler computing environments and it is easier to identify the executable codes. However, the guarding must be tailored to the devices as they may use specialized conventions or constructions. It should also be determined how the device serial numbers or other hardware identifications are accessed. The very simplest devices might have no special hardware identification so the security may have to rely entirely on software guarding.

External guards are used to detect viruses, malware and other undesired software that are usually inserted at the very beginning of a program. They can also detect various kinds of dynamic and clone attacks because their checking is not synchronized with the program's execution in any way. For example, program statements 4,025 to 4,167 can be checked externally while statements 11,720 to 11,988 are executing. Indeed the external guards can check a program while it is idle as long as its code is accessible in memory. The external guards are either within other components of the fortified system or are independent guard agents dedicated to guarding other programs. The external guards use data about the checksum values derived from within the programs when they are being tamper-proofed. Of course, external guards agents may also be tamper-proofed.

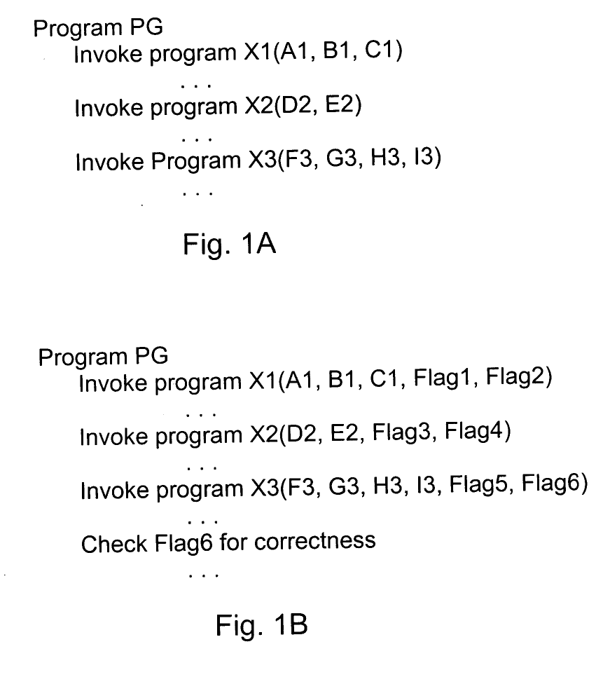

External guards can be distributed over several components of a fortified system. First a guard can check several different programs at once and combine the results and then test. For example, a guard could checksum one statement from each of thirty seven programs and then test the resulting hash result. Second, the code of the guard itself could be distributed over several different programs. FIG. 1 shows an example of such a guard's external guard system.

FIG. 1A shows three invoke statements in a Program PG that invoke programs X1, X2 and X3, respectively. Each invoke statement passes several arguments to the program being invoked. FIG. 1B shows some possible replacement code for the three invoke statements in Program PG. The replacement statements pass additional arguments, Flag1-Flag6, to the invoked programs. These additional arguments can be used by guards to pass checksum values or intermediate checksum values back and forth between the subprograms to detect tampering. The replaced code shown in FIG. 1B includes a statement where Flag6 is checked for correctness, and if the value is not correct a protective action can be taken.

There are different approaches for implementing of external guards and the communication for external guarding. Higher security results can be obtained by mixing these different types of communication in a fortified software.

One way of communicating is through direct reading of the code. The external guard G reads code from another program P and computes the checksum of some code segments just like an ordinary internal guard does. The guard G can locate the program P through the standard mechanism for invoking programs. The disadvantage of this approach is that the external guard has a signature that can be used by an attacker. The guard G is reading the instructions of another program. This is an unusual action which might give an attacker clues about the identity of the external guards.

Another communication mechanism is communication via arguments. Here the external guard G calls or is called by another program P and communication is through the arguments of the call. A guard G can invoke a program P and pass an argument A which the program P uses to return a computed checksum value to guard G. No test should be made within the program P of this value and probably this value is not used within the program P. The technology for creating secure identities can be applied to this value so that the actual value returned changes from time to time.

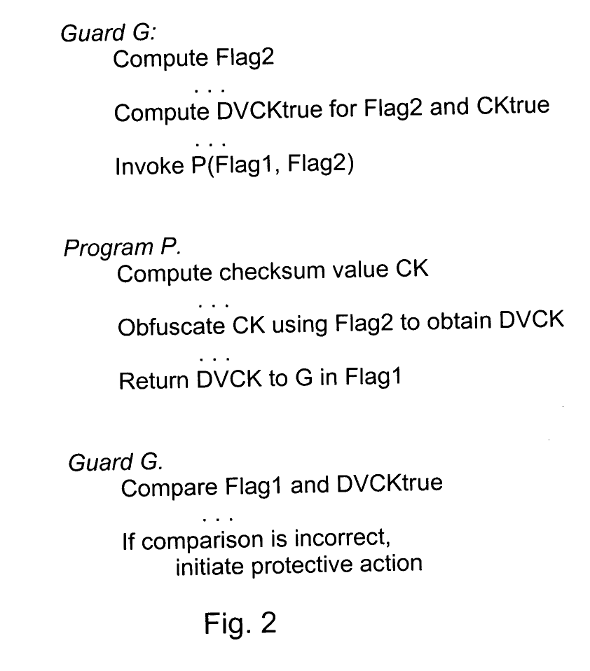

An example of communication via arguments is shown in FIG. 2. The true value of the checksum, CKtrue, is already known by the guard G. The guard G computes a variable Flag 2 through some random process. The guard G then computes a disguised value for the checksum, DVCKtrue, using the true value of the checksum and the random variable Flag2. The guard G also calls the program P with two arguments, Flag1 and Flag2, Flag2 containing the random variable computed by Guard G. The program P computes the checksum CK, obfuscates the checksum using the random variable Flag2 passed from guard G to obtain the disguised value DVCK, and then returns the disguised value DVCK to the guard G in the first argument Flag1. The guard G then checks the disguised value returned by the program P with the true disguised value computed earlier by the guard G. If the comparison shows that the returned value is incorrect, protective action can be taken.

This process of communication via argument can be reversed to have P contact the guard G. The advantage of this second approach is that it makes it more difficult to identify external guards. Of course, more sophisticated interactions and networking can be used to increase the difficulty of identifying the external guards. Checking via arguments can also be incorporated into normal interactions among the components of the fortified system as illustrated in the example of FIG. 1.

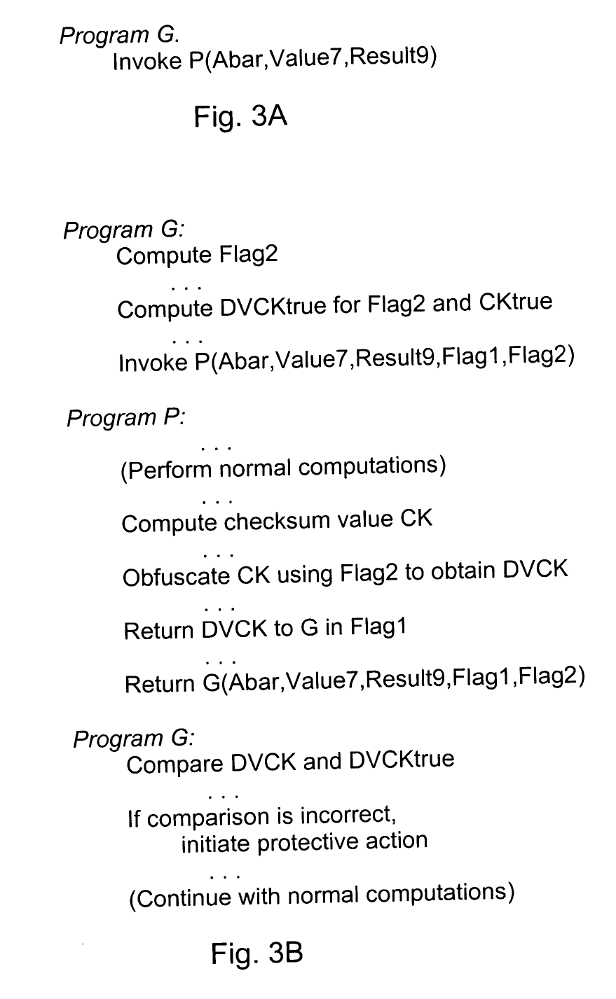

Another communication mechanism is piggy-back guarding on to normal communications. An example of this mechanism is shown in FIG. 3. Suppose that the program G has a normal need to call the program P through the invoke statement as shown in FIG. 3A. This invoke statement can be replaced by the invoke statement shown in FIG. 3B which includes two additional arguments, Flag1 and Flag2. The program G computes a variable Flag2 through some random process, and then computes a disguised value for the checksum, DVCKtrue, using the true value of the checksum and the random variable Flag2. The program G also calls the program P with two arguments, Flag1 and Flag2, Flag2 containing the random variable computed by program G. The program P performs its normal computations and mixed in with these computations performs some additional computations shown in FIG. 3B. These additional computations include: computing a checksum value CK, obfuscating the checksum value using Flag2 passed from program G, and returning the disguised checksum value DVCK to program G through the argument Flag1 along with the other arguments of the invoke statement. The program G then includes the additional code to compare the disguised value DVCK with the true value of DVCK and takes protective actions if the comparison is not correct.

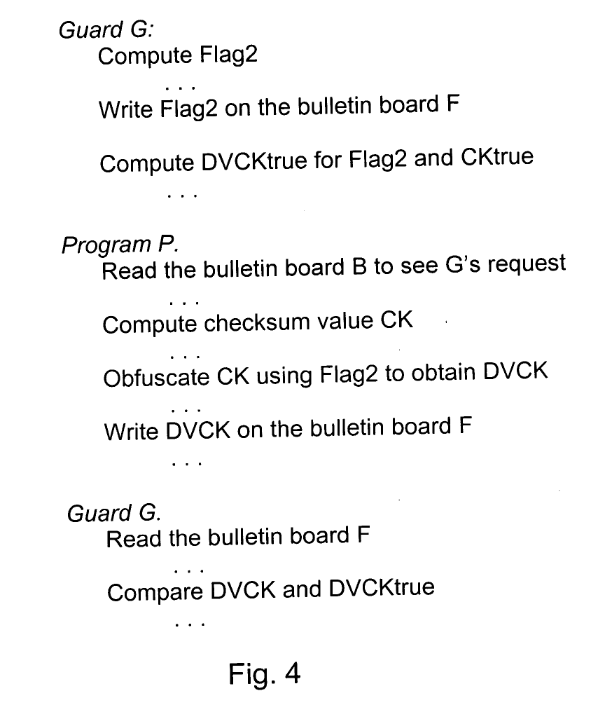

The fourth communication mechanism is communication via bulletin boards or files. Here a program P and a guard G agree to use a file F or similar entity as a bulletin board for passing information back and forth. An example of this is shown in FIG. 4. The guard G computes Flag2 through some random process, and writes the value of Flag2 on the bulletin board or file F. Guard G also computes a disguised value of the true checksum DVCKtrue using Flag2 and the true value of the checksum. The program P reads the bulletin board F to see the request from guard G. The program P then computes the checksum value CK and obfuscates it using Flag2 read from the bulleting board F to obtain a disguised checksum value DVCK. The program P the writes DVCK on the bulletin board F. The guard G reads the bulletin board F and compares DVCK written by the program P with the true value of DVCK and takes the appropriate protective actions.

There is a potential problem from having a guard in one program guarding code in another program. The information the external guard uses affects the guards protecting it wherever it is located. Thus there can be a cyclic effect, where guard A depends on information about guard B, which depends on information about guard C, which depends on information about guard A. The guarding technology disclosed in U.S. patent application Ser. No. 11/178,710, entitled “Combination Guard Technology for Tamper-Proofing Software” includes techniques to handle the cyclic effect and is applicable to external guards as well.

Internal virus guards provide some protection against viruses in some dynamic or clone attacks by immediately checking the first few statements of a program. Some examples of these types of guards are provided later in the application. An internal guard cannot usually detect tampering of the first few statements within a program because it does not have the opportunity to execute before the malware executes. Using a dynamic attack, the malware can be inserted, execute and then repair the beginning of a program so that internal guards do not detect the attack. In fact, malware can be inserted at any point in a program that is executed before it is guarded. It is often quite difficult to identify such locations in a program which create difficulties for both an attacker and for the guarding. One way to do this is to have the first guard of a program check the entire program. There is a large penalty in execution speed for such a guard, but it may be done in some critical cases. However, a network of interlocking guards can overcome this weakness by including one guard very close to the beginning of the program that checks the start plus some guards to check the empty spaces in the code. That guard is then protected by all the guards in the network.

External virus guards are external guards specialized just to provide protection against viruses and other malware inserted into a component of the fortified system without affecting the normal action or code of the component. Unlike the virus guards discussed earlier, they just check the start of each component plus the end and empty spaces. This checking must be done before the components execute, for example as they are installed or brought into working memory from disk storage. These can be organized as an independent network, as part of the overall external guard network, as individual guards (one per component) or into a single global virus guard that protects all the components. Making these part of the overall external guard network is the most secure, and the single global virus guard is the least secure. Microguards are well-suited for use in external virus guards. Microguards are very short guards (one or two statements) that can check one item in a program, they are very hard to detect and execute very fast.

Distributed and networks of external guards can provide protection of component P that cannot be removed without removing all the guards simultaneously from the component. Attacks on fortified software are likely to first focus on identifying and disabling the internal guards. This protection is extended in the fortification of fortified software and is, in fact, even stronger. A distributed guard is one whose parts are distributed over a number of programs including the program P and these parts communicate just as the external guards communicate. To remove such a guard requires that all of the parts be removed or otherwise the guard's protection will be triggered.

A network of external guards is created by linking sets of internal and external guards in several components of the fortified software. This creates two types of guard networks; those inside a single component and the external guards. There can be external guards checking a component's guard network silently in the sense that a component does not have any awareness of an external guard computing a checksum of its code. There are also external guards which use stealthy access to internal information for guarding. It requires very sophisticated analysis of the system's operation even to identify such an external guard. Further, the timing of external checking is not synchronized with the component's execution.

The external network should include guards that merely check the completeness of the network. A set of very lightweight guards (for example, microguards) can just check for the presence of larger external guards and of each other. These execute very rapidly and thus they impact computer performance very little. In a high security application there can be hundreds of such guards that would have to be removed or disabled within a very short time in order to avoid detection of the attack. Overall, the security of fortified software is greatly enhanced compared to just tamper-proofing its components one by one.

Viruses are an example of malware. The virus guards provide protection against other attacks and against the insertion of malware in general. A virus guard can protect against dynamic and clone attacks. External microguards are also very useful to protect against these attacks.

Hardware and environment guards are also useful for more global protection of fortified software. There are two primary types of hardware and environment guards: guards that check to see if certain hardware devices are present, and guards that are implemented in hardware to check certain simple properties of the fortified software. Some of these simple properties can include connectivity of some components of the fortified software, presence of some devices, or presence of some codes. These just make simple, common sense checks that the fortified system is all there and in reasonable shape.

Data protection has two primary aspects. The first aspect is detecting if data items have been changed, and the second aspect is preventing unauthorized access to data. The first aspect of data protection is essentially the same as tamper-proofing code. One has guards to check if data has changed. Thus, this aspect is subsumed under guarding, either internal or external. The second aspect is one of the more difficult tasks of software security. Using passwords as an example, the password must be available for use but must not be visible for an outsider to see while examining or executing the software.

There are three distinct types of data to hide. Internal data that is used within the component, which can include passwords and encryption keys. System data that is used only internally within the system, for example private and shared identification information. All of this identification information used for name security is of this type. External data that is to be provided outside the system, for example bank accounts, IP addresses and telephone numbers.

Hiding data internal to the fortified software system is quite feasible but may not be easy. Hiding external data is not feasible since the data must eventually be presented outside the fortified system. Outside the system it is vulnerable to being observed and discovered. If the external data is to be protected, then normal security measures can be used but the fortification of the system should not depend on this being secure. Note that system data is actually handled just like internal data. However, the system components must collaborate to use the data without exposing it. This collaboration requires planning and special handling but can be made as secure as the hiding of internal data. In many cases, it is sufficient to encrypt the data before it leaves one component and to decrypt it once it is received by another component. In some environments this security might be applied automatically for all communication between some or all of the system components.

There are two general information hiding technologies available to hide data items: encryption and obfuscation. Encryption can hide data very securely except that care must be taken that the data is not decrypted in order to be used. If it is decrypted, then monitoring the execution of the software can allow the data to be seen while it is not encrypted. But the encrypted form of the data, for example a password, can be used directly. For example, by encrypting the password presented by the external contact and comparing the result with the encryption of the true password.

Obfuscation provides ways of data item hiding by transforming computations or information so that one cannot discover what is being done. For example, a simple password test might be made by transforming the password several times to compute several or hundreds of different numbers. Then computations are introduced whose correctness depends on these numbers being correct. This is an instance of silent guarding techniques where checks are made silently if the data has been changed. If the data has been changed, then the program's operation is corrupted and this corruption often takes place in unpredictable ways.

The level of difficulty of retrieving the information measures the level of security of the information hiding. One simple example of obfuscation is to hide the numbers 867,193 and 30,541 by computing their product 264,849,413. Factoring the resulting long product is very difficult if both 867,193 and 30,541 are prime numbers. This type of data hiding is the basis of many encryption schemes. Other simple examples are to translate text from English into the Navajo language, or to translate a program from a high level computer language such as C++ into absolute machine language of a 1960s computer. The results can be very effective ways to obfuscate the original content. Data hiding for software can use both language techniques and computational (mathematical) techniques. The level of security possible is known to be quite high, and it is widely believed that the security can be increased by applying more and more obfuscation.

Reliable identification and authentication is an essential component of fortified software and of any software security system. A system can be attacked by spoofing, in which an unauthorized component (person, program, etc.) gains access by masquerading as an authorized component, and then carrying out an attack to obtain information, to provide bogus information, to obtain services, to pirate code, or for other purposes. There is a very large technology to identify the components that might be in a computer system. This technology can be tailored to the requirements of fortification of computer systems.

The term “component” is used to refer to programs, systems, persons or other entities that are a single entity as far as the system is concerned. An insider component is part of the fortified system and an outsider component is not. Components interact via contacts. Contacts means different things depending on the capabilities and nature of the component. One component may be invoked by another component or it may communicate via email or message boards. In any of these cases a name is used to identify the component being contacted.

We introduce three different types of names for components: public, shared and private. A public name of a component A can be widely known and can be used by any entity to contact the component A. Each software component has a public name which is generally publicly known though it does not have to be. A shared name is known outside of the system, but it is intended to be known by a limited number of outsiders; and steps are taken to ensure that an outsider using the name is actually authorized to do so. A private name is only known within the fortified system itself and no outsiders are supposed to be aware of it. Stronger steps are taken to ensure that a system component using the private name is actually an insider. A component may have many names (pseudonyms or aliases) for each type. One purpose of multiple levels of identifiers is to combat spoofing. A component might respond to the use of its public name in some situations and not in others.

Software components are the building blocks of software systems, and one of the principal attacks on the security of software systems is to modify or replace a system component. This can be done by changing the identity of one of the components of the system. The identities of the software components for a fortified system should be both secure and efficient. Providing secure identities can be done through many different methods such as providing a secure hash function of a program's code to provide the identification. However, it is expensive to continually compute hash functions to verify identity. Testing identity can be done securely using, for example, zero-knowledge comparisons. Such comparisons however involve many rounds of communication depending on the level of security that is desired and each round may involve significant computation. The security system should be able to provide secure identification that is efficient and which allows for privacy in the sense that the software component can safely use pseudonyms which do not reveal its true identity.

There are three fundamental differences between software identification and personal identification. First is the fact that software can be copied easily and exactly whereas people cannot. Thus, maintaining a unique identity for software includes an issue involving physical and electronic security. Second, identity for people in practice involves both identification and certification. Examples of certification are: (a) I have a valid driver's license; (b) I am a citizen of France; and (c) I have rented a car until December 29^{th}. Furthermore, identities, both electronic and physical representations, for people can be copied and/or loaned which means that certifications can be loaned. This combination of identification and certification creates considerable complexity for personal identification which is not present for software identification.

The fundamental mechanism for highly reliable software and personal identification is the same. One has a very complex identification structure from which a small subset or signature suffices to establish identity. For a person, the identification structure includes physical characteristics (e.g., fingerprints, voiceprints, face prints, walking gait, keystroke behavior) and internal information (e.g., knowledge of passwords and personal history). For software, there are no physical characteristics but a complex internal information structure can be created to form the basis for secure identification. These structures can be both efficient and secure in the sense that they cannot be broken or reverse engineered by observing and analyzing the signatures, are secure against typical attacks like replay, provide for essentially an unlimited number of pseudonyms, and allow complete privacy.

A program has a name, many pseudonyms, and an identification. The identification is the complex structure embedded within a program from which it generates the signatures used for identification. The signatures can be derived directly from the program's innate identity.

For example, consider a simple program named P with instructions in a fixed format (e.g., an executable object file). Then its identification is its set of machine instructions indexed 1 through N. A signature of program P is a subset S of the program's instructions, for example instructions K1 through Kj. In this example, assume that N is 8,000, j is 5, and each instruction has 32 bits. Then a signature has about 5*(13+32)=225 bits. There are potentially about 10⁷⁵ different signatures possible for the program P, but the bits are not actually random, so the actual number of different signatures is much smaller. Even so, the number of different signatures is very large, probably more than 10¹².

As another example, the program P can identify itself with a pseudonym and select a signature S=(kᵢ, Iᵢ) for i=1 to 5 for five random values kᵢ, where Iᵢ is an instruction of program P. This creates another name for the program P which has the identifying signature S. If the program has only forty instructions and uses five of them per signature, then it can generate over 650,000 distinct signature and pseudonyms pairs. It can then pass a pair (P, S) to another program Q, and then use them for communication with the program Q.

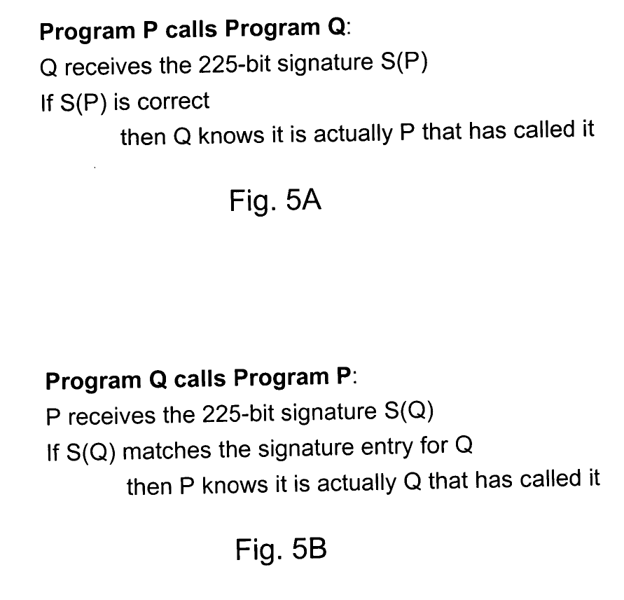

When a program establishes contact with another program, there is a registration event where the identity information is exchanged. In practice, the registration normally occurs when the programs are assembled into a system and is carried out by the system builder. For example, if a program P is to establish contact with another program Q, then the program P gives the pair (P, S) to the program Q where S is the signature of the program P which the program Q can use to identify it. A simple example of this communication protocol is shown in FIG. 5. Consider that program P calls the program Q, or the program Q calls the program P. The word “call” means “contacts” or “sends a message to.” The identification protocols for the two scenarios takes place as shown in FIG. 5. In FIG. 5A, when the program P calls Q, Q requests or expects the 225 bit signature S of the program P and if it is correct then Q knows that it is actually P that has called it. In FIG. 5B, when the program Q calls P, the program P expects the 225 bit signature of program Q, and if it matches the signature entry for Q, then the program P knows that it is actually Q that has called it. Of course, there can be a mutual exchange of signatures for added security.

These protocols illustrate basic mechanisms for using identification signatures. More complicated protocols are used to increase the security and to foil other types of attacks. Even so, this basic mechanism makes it difficult for one program to fool another by some type of exhaustive trial and error or pattern analysis of possible signatures.

The identification discussed above is actually very efficient in that it requires very little memory and computation. By using more (index, instruction) pairs, the program identification can be complicated to the point that brute force attempts or exhaustive search to find a correct signature can become pointless. However, this method can have shortcomings in certain instances. One instance is if the program does not have a built-in index of its instructions. Another instance is that the number of possible pseudonyms may be quite limited if the program is short, especially if an (index, instruction) pair is never reused in a signature. Yet another instance is the potential for leaking the code of the program if there is collusion among programs interacting with it. That is, all or almost all of the program's instructions could be collected by other programs which pool their knowledge to discover the program's instructions.

One alternative for the identification structure that does not have these shortcomings is to create signatures using data lists. Instead of the actual code of the program P being the identification data list, a separate list of random content, call it IDlist, is inserted into the program P to identify it. The IDlist can be tailored to the application and security level requirements. Thus, the IDlist can be a random list of 10,000 8-bit numbers, or a list of 1,000 80-bit numbers, or a list of 10,000 80-bit numbers, etc. The size of the list and the number of items in the signature can be used in the tailoring. This approach may be expensive in memory usage for a short program, however for a program with hundreds of kilobytes of code this approach may increase the length very little and it is very fast to compute and verify a signature.

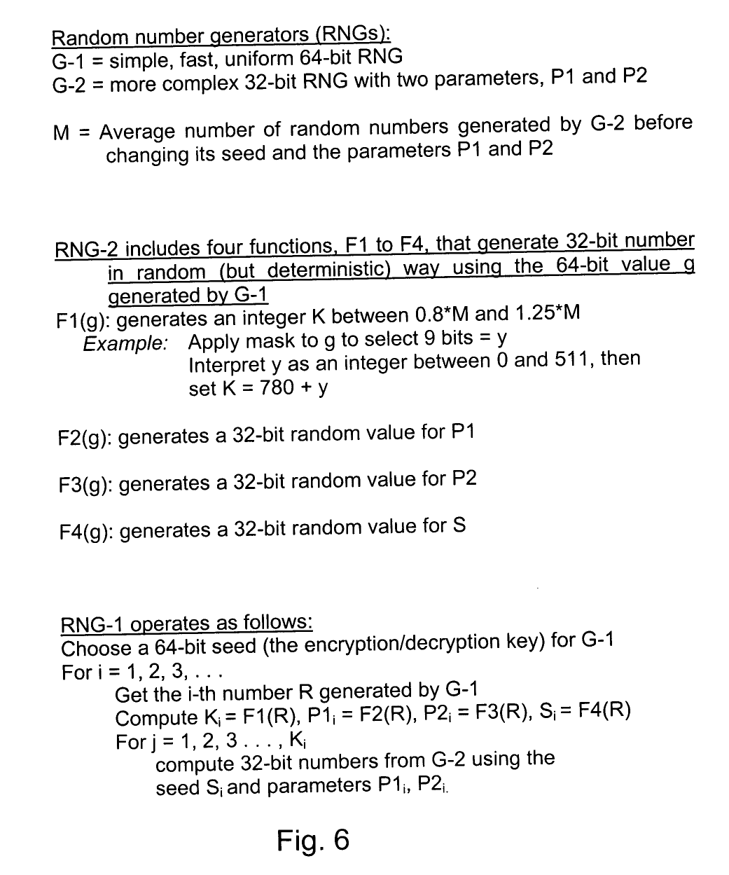

Another alternative identification structure is to create signatures with random number generators. Instead of having a list of random numbers one might simply use a random number generator. Compared to the above example, one is trading off memory usage for computing time. However, the amount of computing time required is low and essentially fixed, and the complexity of the random number generator can be made extremely high. The technique of the one (1) pass random number generator can be used. An example of this type of identification structure is shown in FIG. 6.

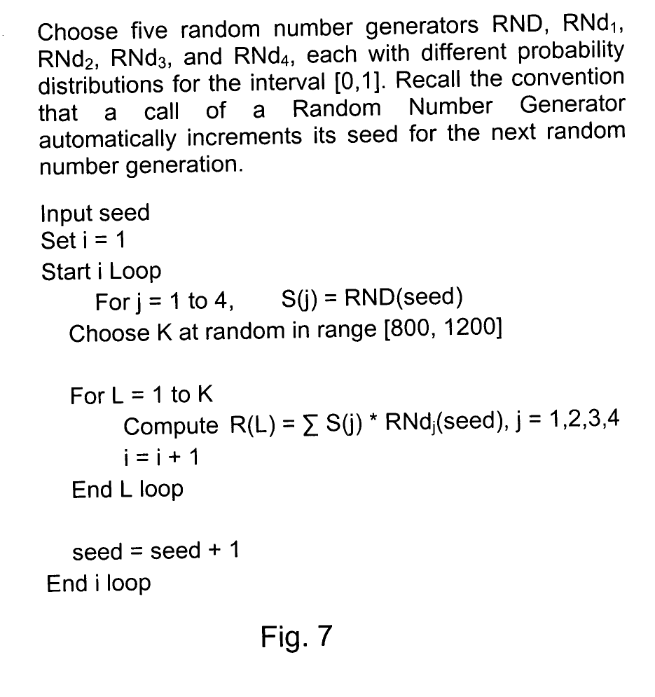

FIG. 6 shows a system using two random number generators: G-1 being a classic uniform random number generator with 64-bit arithmetic, and G-2 being a more complex random number generator with 32-bit arithmetic and two parameters, P1 and P2. K is the number of random numbers from G-2 used before changing its seed and the parameters P1 and P2. This identification process also uses four functions. The function F1 described in FIG. 6, takes a 64-bit number and generates an integer between 0.8*K and 1.25*K a value generated by random number generator G-1. An example for F1 is to apply a mask to a value generated by G-1 to select 9-bits and call it y, then interpret y as an integer between 0 and 511, and take K=780+y. Thus, K, the number of random numbers generated by G-2 before changing its seed and parameters, would be between 780 and 1291. The other functions F2, F3 and F4 take 64-bit numbers and generate 32-bit numbers in a random but deterministic way. This could be simply a mask applied to a random number generated by G-1 or something quite complicated. Using the random number generators and functions described above, the process then operates as follows. A 64-bit seed is chosen for the random number generator G-1. Then it enters a loop with index i, in which it retrieves the i-th number R generated by G-1, and using R and the four functions F1-F4 computes the parameters K, P1, P2 and the seed S for G-2 as shown in FIG. 6. Then it enters a sub-loop for j=1 to K in which it computes 32-bit random numbers using G-2 with the seed S and the parameters P1 and P2. After M steps, this scheme generates about M×K random 32-bit numbers. Thus, a few dozen lines of machine code can generate a virtually unlimited number of unique signatures. Using one random number generator alone is not secure because, with a very large amount of data, statistical attacks can determine the generator and the key. Using the two random number generators together with one seed and pair of parameters for a limited number of iterations, preferably less than 10,000, is very secure from statistical attacks. Note in FIGS. 6 and 7 that the convention for random number generation is that the seed is automatically incremented on each call to a RNG without any explicit indication of this fact.

FIG. 7 shows an alternative example of an identification structure which illustrates the wide range of possible random number generators that can be used for identification. Choose five random number generators RND, RNd₁, RNd₂, RNd₃, and RNd₄, each with different probability distributions for the interval [0,1]. They need not be classical or standard distributions. RND is used to create the seeds for the other four random number generators which are used together to generate the desired random values Rᵢ. As shown in FIG. 7, the process is initialized by setting i=1 and inputting a seed. Then an outer loop with index “I” generates new seeds: seedj, j=1, 2, 3, 4 from RND(seed) for the other four random number generators, and chooses K randomly in the range 800 to 1,200 to set how many numbers will be generated using these seeds. The value of K can be selected using S(1) in a method similar to the example shown in FIG. 6 for selecting K. Then the inner loop from 1 to K generates the desired random values R=ΣSⱼ*Rnd(seedⱼ), j=1-4 and increments i. This algorithm could be simplified since only a few numbers are generated at a time. The complexity of this algorithm is used to defeat any attack based on a statistical analysis of the random outputs.

Checksums and hash functions can also be used as alternatives for identification structures. The idea of using a hash function to checksum data lists can be applied in many other ways. First, one can checksum any list of numbers including those of a signature, i.e., the data lists, the random numbers used in the preceding examples or the object code of a program. The advantages are: (1) the checksum is shorter than the data itself, so there is less to communicate, (2) the source of the signature is further obscured, so it is impractical to determine the original signatures, (3) the need for security in communication is reduced, and (4) it is faster to check the signature. The disadvantages are: (1) it is more work to compute the checksum and its hash function, and (2) if enormous numbers of signatures are needed, there is a very small risk that they are repeated.

There are various security levels of identification information, IDs. When component A is contacted, the contacting entity uses a name and may also provide some auxiliary information about its identity and authorization. This identification information determines the identification security level of an ID and there might be a sequence of challenges or exchanges of information as in a challenge response situation. When A is contacted, it examines the identification information. Even when component A is in the public mode it may examine this information to detect erroneous contacts such as being provided a character sequence when a number is required, or being provided a negative number when a positive number is required. The identification information is to provide component A with the means to check the authorization for the contact. A password is the simplest and most common means of providing some security when contact is made. The security of transferring identification information between components is preferably handled by a secure infrastructure.

We identify four levels of identification security for components: none, password secure, semi-secure and secure. The first is no identification security which is where component A may check that the identification information is operationally valid but otherwise assumes the contact is authorized. If the contents of the identification information can be ascertained from easily available knowledge, then there is no intrinsic security in its content.

The second level is password secure which is where component A checks the identification information to make sure that it has the correct content such as a password. This content is invariant, so that, once compromised, any outsider with this content is authorized to use A. Obviously there can be a wide variety of actual security strengths within this level.

The third level is semi-secure which is where the component A is contacted by a component B and then there is an exchange of information of a challenge-response type. The exchange is said to be simple if the logic behind this exchange is simple. That is, the rules for the response could be guessed by observing a fair or perhaps large number of exchanges. A simple example is for A to send B a number N and then B to return a password plus the date of N days in the future. Another example is for A to send B a number N and then B to return the result of a logical exclusive-or operation on the password with the date N days in the future. This definition depends on the meaning of simple. We say the rules are simple if a person knows them could easily remember them for several days without writing them down or using ten to a thousand examples or exchanges could derive the password algorithm. Thus a person who knows something about the rules of B could imitate B and gain access to the component A.

A secure identification security level is where component A interacts with component B in a way that requires very large amounts of information and logic in order for B's identity to be accepted. This would require at least dozens of lines of code to compute the data and/or dozens of complicated data items. Examples are where B is a person and provides his fingerprints or similar biometric, or B is a program and receives a set of K numbers N from the program A and returns K words from a particular secret book at location N. We assume that communication and transport in infrastructure are secure.

The dividing lines between password secure, semi-secure and secure can be fuzzy but are useful for determining a security level. Nevertheless, these definitions do illustrate general ranges of security in identifications and the security of a fortified system is dependent on secure identifications of the components. The principal danger is that an ID is compromised so a program or person can spoof the fortified system using a false ID to gain some advantage.

The automatic creation of secure IDs from machines and software components is preferred for large and/or dynamic systems. High security requires that these identities have the privacy properties similar to personal biometrics. Fortified software usually needs identification that is efficient in both computation and communication as components might check identities very frequently, on the order of every millisecond or microsecond. Some techniques using random number generators can be used to achieve this secure identification of software necessary for fortified software just as biometrics have inherent random characteristics. When a new component or device is introduced into a fortified system, new secure identities are created for it. A very simple model of this would be to use a random number generator to create a new 16-character alphanumeric password for a password-secure component.

This approach is made highly secure by increasing the complexity of the information and the protocols for the exchange of information. If there is no predictable relationship between the input and the identification values, then a secure ID exists.

A fortified software system is similar to an organization that wants to assure its integrity, i.e., that all its members are exactly the ones expected. Such a software system might require very high security and have ten, a thousand or a million components operating on various devices (PCs, fingerprint readers, network servers, optical scanners, etc.). There are many aspects to fortifying such a system and one of these is that each software component must be positively identified. Many of them need several pseudonyms, each to be used for communication to a different class of other programs. It must even be able to differentiate among several “identical” programs which run on different PCs or devices. Highly secure operations may require that the identities of programs be verified more than just with each use. For example, external security monitoring components of the fortified system might verify software identities every few minutes, seconds or milliseconds. Such a system is likely to be static in nature; that is, it is set up or up-dated infrequently and then operated very frequently.

A typical component needs to interact with other components of the system, components of other “trusted” systems, with entities that have the authority to modify certain of its parameters or properties, and external “untrusted” objects (people, programs, devices, etc.). The component should use a pseudonym and signature for interacting with each class of programs or components. Different levels of identity security are required, for example, none is needed when interacting with an untrusted entity.

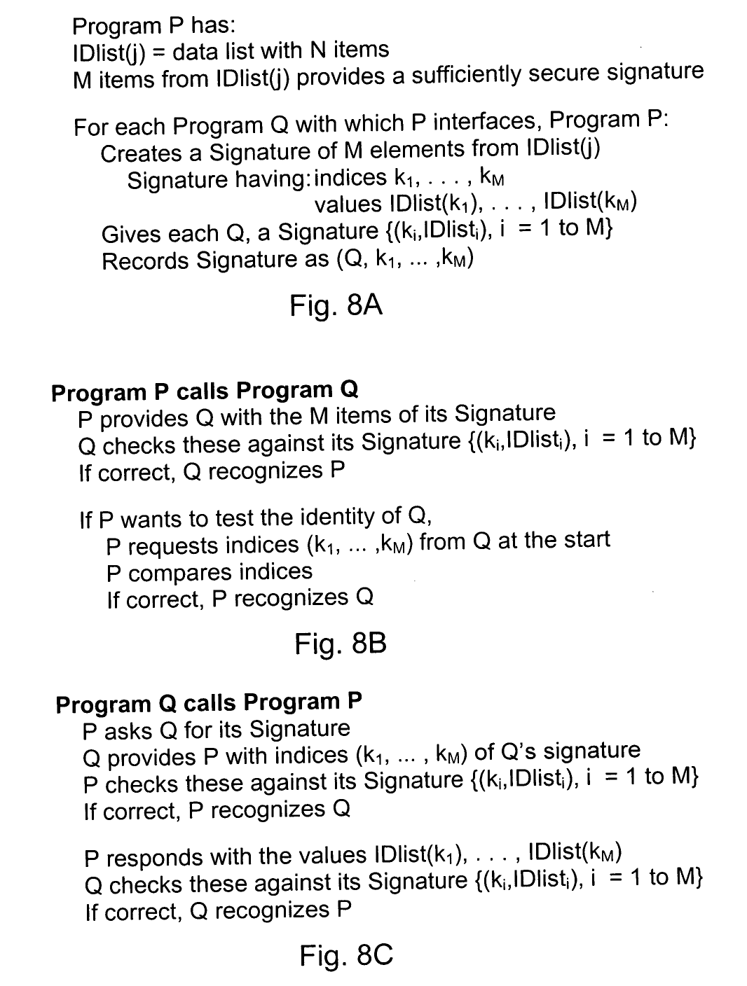

Preservation of privacy means that no collection of signatures that occurs is sufficient to reveal the “true” identification information about a program. This concern is very important for people (e.g., fingerprints) but it is also important even for some software. An example of the technique for protecting privacy is shown in FIG. 8. The program P has a data list, IDlist, of N items and we assume that M items provide a sufficiently secure signature. For each program Q that the program P interacts with, P creates a set of M elements from the list, IDlist, as its signature. Then program P gives each program Q, the signature {(kᵢ, Iᵢ), i=1 to M} and records the signature as (Q, k₁, . . . , k_{M}). Then when either program contacts the other, the identification protocols are as follows.

When program P calls program Q, program P provides program Q with the M items of its signature. Program Q checks these against its set and, if correct, recognizes P. If program P wants to test the identity of Q, it can ask Q for the indices (k₁, . . . , k_{M}) at the start.

When program Q calls program P, program P asks program Q for its signature as above. Then program Q provides program P with its set of indices (k₁, . . . , k_{M}) of Q's signature and program P responds with the correct values (I₁, . . . , I_{M}) to be recognized by program Q.

The security lies in the fact that there are so many possible signatures that none is ever reused and even collusion among thousands of program provides little information about the signature of program P. For example, if N=10,000 and M=5, then there are about 10¹⁸ signatures possible. Even if the signatures are chosen at random, there could be 10,000 signatures with a substantial probability that many items are not used. By managing the assignment of items to signatures, a huge number of signatures can be created without compromising the security. If a random number generator is used instead of a data list, then the list effectively has millions of items and there is no risk of revealing the entire set of items.

The program P can create and launch other programs, call them agents, to help with various tasks. These agents can be used to search the net for information, to monitor devices or sensors that detect certain events, or to collect data on events occurring in a wide environment. These agents are probably somewhat autonomous and they must have names for a program to contact them, and identifying signatures for contacting a program. These agents must also be able to identify a program. In some applications, the agents can contact the desired program using a pseudonym, and in other applications, the agents simply wait to be contacted by the program.

As the use of software agents matures, agents will create new agents, which in turn, will create even more agents. These agents obviously need to interact with their creators; they may need to be able to interact in some way with the original or an intermediate creator in their ancestry, and to be able to recognize other agents that are descendents of the original or an intermediate creator in their ancestry. There might be thousands of such agents, each with a separate pseudonym and identity signature.

This identification technology places no constraints on the organizational form of the agents. The organization can have 2-way communication (each agent knows the other's identification), 1-way communication (only one agent knows the other's identification), or a mixture of these. Communication can be restricted to be “up” only, “down” only or “horizontal” only. The organization can be very structured (all agents know the entire organization and its structure) or amorphous (agents know they belong to the organization but do not know their position in it). Each agent needs an address book with perhaps a few entries or perhaps a very large directory. But each entry is of a reasonable size, perhaps a few dozen bytes. The organization can change dynamically with agents added or deleted easily. There can be a central information service to provide addresses for large organizations provided measures are taken to secure the service.

Assume that a program P is in charge of a search for terrorists and uses agents sent out over the internet. Each agent has
its own ID,

the ID of its creator,

the IDs of its siblings,

the pseudonym (flycatcher) of Program P but without the signature,

the signature of the agent network.

The network has a tree structure with Program P at the route. Agents may create sub-agents to extend the network. The agents have some detection technique to identify potential terrorists. Once a potential terrorist is identified the agent:

sends a message to flycatcher,

provides all the information to its creator who sends it up the network,

provides all its siblings with all the information.

These communications all use the agent IDs and network signature for secure identification of the participants. In case the network is damaged, Program P has the information and IDs to contact all the surviving agents. It is clear that such a network can be organized in many ways and use many protocols as suited for the network's goals.

Software can also be used as an aid in identifying people. Reliable identification of people depends on assessing complex biometric characteristics of people such as faces, fingerprints and speech patterns. People have built-in mental facilities to support remembering some types of biometric identification but these facilities are not always reliable. Thus, society has generated mechanisms to support identification such as photo IDs and passports. In most situations the person produces his identity (produces credentials and/or allows biometric data to be measured) and this is compared with reference identity data. This approach is very reliable but there is the risk of the biometric data being stolen. There are various methods for securing the biometric data by allowing identifications to be made using subsets of the biometric identification. This process is the same as using signatures to identify software.

Personal identification that provides high levels of privacy and security requires computational support. People cannot perform the measurements, computations and transformations mentally. Further, there is an ever growing need to make secure identifications at a distance, e.g., over the network. Thus various computational aids have been developed to assist people with managing their identity data. The most common are smart cards that include both computational power and memory. Protocols and systems to protect personal identity information primarily use encryption and other standard security techniques. The personal identification problem using these aids has two components: problem (a): secure identification of the computational aid, and problem (b): reliable association of the computational aid with a person. If problem (b) can be solved then there is no need to use biometrics in the identification process.

There have been several solutions proposed for solving problem (b). One solution is embedding the aid as a computer chip in a person's body. Such a device has been approved recently by the FDA, but it is extremely simple. Another solution is using a challenge-response conversation to verify that the aid and the person both “know” the appropriate information. This expands the password concept into something that is both more reliable and more natural for people. Yet another solution is having people transmit transformed biometric information securely so that the aid can identify the person but no one else can interpret or use the transmitted information. This topic is discussed later as such transmissions are also needed for securing the integrity of software systems.

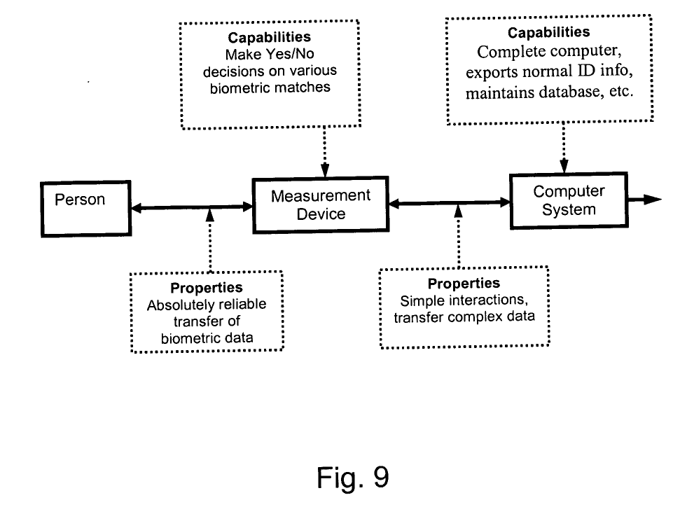

FIG. 9 shows an example of a system for secure personal identification. We first assume that there is some way to connect a secure computation/communication device to a person such as using a brain implant, measuring brain waves externally or using a dynamic DNA testing device. We also assume that this device is very small so that it communicates with a normal sized device that provides external identification. The configuration is illustrated in FIG. 9. The measurement device deals with the measurement and transfer of biometric information. The computer system manages many interfaces to the outside world. It maintains a database of identification related items: names, addresses, member numbers, signatures, etc. These are related to the persons and entities that the computer system and the devices it interfaces with will deals with. Note that the computer system is not essential to the person's security, all the person's biometric data and processing takes place on the measurement system. Of course, it is not pleasant to lose ones address book, etc. but that can be backed up reliably.

It is practical, even required, for people to use a computational aid for identification. Even though the use of smart cards is now widespread, the losses due to electronic identification fraud are still enormous and growing. The software identification technology presented here can then be used to provide high levels of security for people and organizations. Further, they can create private and secure software agents to aid their activities.

The purpose of security transformations is to protect against replay attacks or spoofing in communication. For these transformations we assume: (a) that both software components, say programs P and Q, involved have access to some shared or global information that changes continuously; and (b) that programs P and Q share a private function or procedure that uses the shared information to transform the signature each time it is sent. The transformation procedure itself need not be particularly secure. A simple example is a transformation based on time and random numbers. Let the global information be universal time T. Assume the frequency of communication is low, no more often than once an hour. Then T can be used as the seed for a random number generator RNG shared by both components to obtain a random sequence Rand=Rᵢ, i=1, 2, 3, . . . The transformation is then for Rand to be added to the signature S by the sender and subtracted from the signature S by the receiver. That is, P sends {Sᵢ+Rᵢ} and Q uses {Sᵢ-Rᵢ}. This transformation is simple and effective in many cases. Its weakness is that it depends on the frequency of communication and the synchronization of clocks. The clock can be replaced by other items.

One alternative is to use information from the communication history of programs P to Q. For example, maintain a message count M, and use M as the seed for RNG instead of T. Or use some item from the content of the previous message from P to Q. For example, use every seventh character of that message to generate an eight character seed for RNG.

Another alternative is to use information from the current message between program P and Q. For example, use the first 8 characters of the message as the RNG seed to generate the sequence Rand and then use Rand to transform the remainder of the message which is its actual content. That is, program P sends Q the message {Aᵢ=Cᵢ+Rᵢ} and Q computes {Aᵢ−Rᵢ}={Cᵢ}, the original message. The first 8 characters of the message are ignored.

Yet another alternative is to use information that is universally available, such as yesterday's Dow Jones closing average, as the seed for Rand.

So far security has been taken to mean that one cannot “break the code” that generates the signatures. This is, of course, essential for secure identification but it is not sufficient. We consider three other attacks on the security of software component identification: replay attacks, reverse engineering and physical attacks.

Replay attacks capture the identity information as it is transmitted and use it later. This attack is to copy the information transmitted and then replay it to “impersonate” the software component. This type of attack is widely used against the security of software systems. Fortunately, it can be defeated rather easily using transformations of the signatures; the defense techniques are presented in some detail below.

Reverse engineering involves the study of the program code to determine how the signature is created and then synthesize or copy the identification mechanism used by the program. Recall that an exact copy of the program cannot be distinguished from the original. However, copying is not a great danger if internal procedures are put into the program that prevent its misuse by copying. A complete security compromise can occur if all the code associated with generating the signatures can be recreated for another program to use. Protection against reverse engineering is a security issue orthogonal to identification. The measures used to prevent reverse engineering use a combination of obfuscation and tamperproofing (guarding) technologies.

Physical attacks modify the hardware of the machine that executes the program to alter its behavior, extract information, or for other unauthorized purposes. Again, these attacks are orthogonal to identification and sufficient measures must be taken to assure the integrity of the hardware that executes the program. One important type of protection is to include code in the program that tests hardware identity and its characteristics thoroughly.

Reliability refers to a loss of functionality as opposed to a loss of security. Thus, if communication is lost within parts of a fortified software system, the identification becomes unreliable although still secure. Consider the following examples: (1) Suppose the program P is executing on the machine Atlas and Atlas is destroyed by a lightening strike. How can the fortified system be reconstituted without P? (2) Suppose the cable between two machines is cut. How can the fortified system be restored? Will the entire system be disabled by this break? (3) Suppose the encryption between two machines is accidentally disabled (by an entity outside the system). How can security be restored? These are important issues that must be addressed by the fortification of a software system.

Reasonable responses to these events are as follows: (1) Programs that communicate with program P recognize, after some time, that program P does not respond. There is code within the system to react to this information and an entity that has the authority to restore the system or to modify its operation. (2) The procedure that handles “lost” machines can equally well handle “lost” connections. Often a system has multiple connectivity so one lost connection is easily or automatically replaced by another. (3) A fortified software system should use the general encryption of a secure network but it should also use its own encryption of messages in addition.

The theme of these responses is that events that cause loss of functionality must be anticipated and responses incorporated into the system in advance. A byproduct of these reliability steps is that there must be system backups. This, in turn, creates yet another security problem: one must protect the backups. This can be very important if the code involved is the computational aid for a person's identity. If that code is lost then the person may have very severe difficulties in recovering everything needed. Again, this is not an issue of identity protection specifically, but it is a related issue that must be addressed.

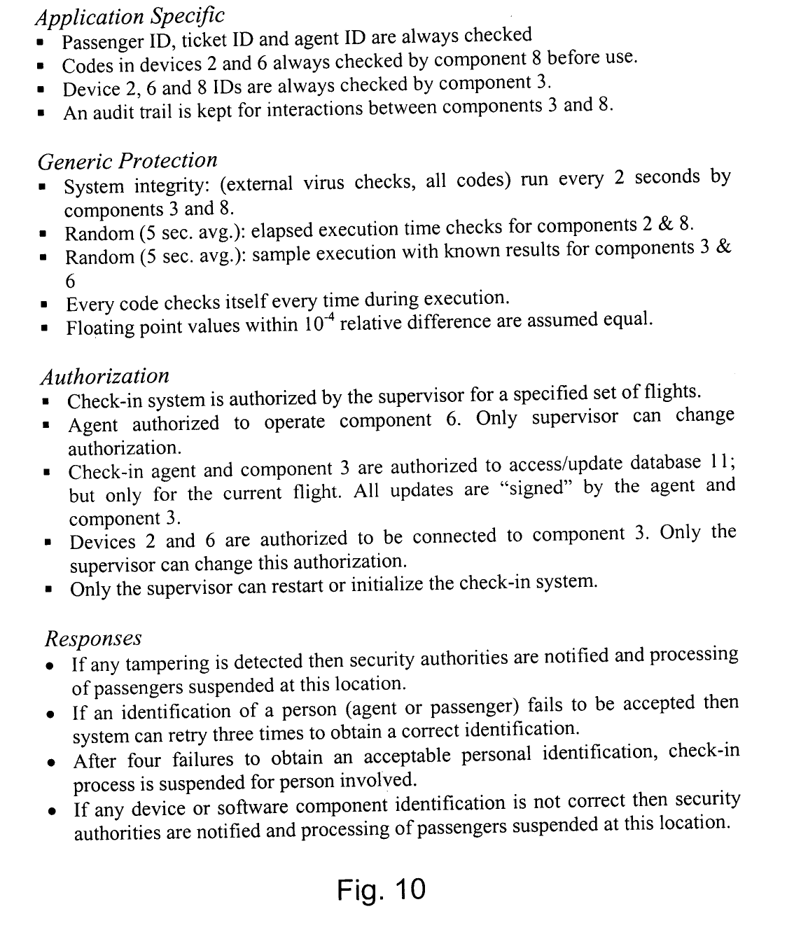

The policy system of a fortified software system has two distinct parts: the parts specific to the particular application, and the parts that provide general software security. The policy system is also a central entity for managing the security, identity and authorizations used by the system. In practice it is preferable to have a single entity managing policy even though this is not essential to security in principle. Otherwise, there is significant overhead in updating security controls and security errors become more likely. Policies can fall into three general categories: (1) policies specific to a particular application of the system, (2) generic system protection measures, and (3) policies about who, how and when authorizations are to be made or modified. FIG. 10 provides some examples of these policies and possible responses in the context of an airport check-in system.

Once the policies are made, then the policy system manages the creation of identities associated with verification information. These identities are inserted at the appropriate places within the system components. The policy system also manages changes in policies. There is preferably someone authorized to change the policies and an audit trail is maintained of the changes.

Guard responses are coded into the program and determined by the security policy. These can be gentle reminders that something might be wrong, urgent messages to security authorities, locks on the entire system, repairing the changed code, or corrupting program execution.

Dynamic policies are those that can be changed while the system is deployed even while it is operating. These are policies that can be modified while changing a few data items in the system software. For example, changing the identity of the person guarding the bank vault can be made by changing a few items within the code; adding a fourth person to run the ski lift can be made by adding a new entry to a database of lift operators along with their identifying information; or a fingerprint reader can be replaced by updating the serial numbers. Practical operational efficiency requires that it be easy to make security changes. Otherwise, people will try to avoid making changes even if they are necessary for high security.

Static policies are intrinsic to the system and cannot be changed without rebuilding some components of the system. For example, changing from a one-level challenge response mode to a two-level challenge response mode requires that new code be added to the components to generate and process the new types of challenges and responses. Of course, several different modes can be included in the system and then a switch can be used to change dynamically between them. It is often impractical to build a highly flexible capability for all of the changes in a system. The system designer must decide which policies are to be dynamic and which are to be static. In practice, it is expected to take several iterations to identify a good balance between the two choices. It is sometimes feasible to automate the rebuilding of certain components so that changing static policies is less burdensome on the system support staff.

The system policy manager has responsibility for all the dynamic policies. Logically, the system policy manager is thought of as a separate system component with global connections to the other system components. There are at least two advantages to having a manager distributed throughout the system. First, especially for a large system, there are simple things that are more efficient to do locally. For example, giving a sixth person the authority to access the fourth floor storage closet should probably be implemented by the software of the building facilities supervisor rather than that of the company's chief security officer. Second, and more important, the security of the system is stronger if the security policy is distributed throughout the system. Thus, instead of having a single system policy manager that can be attacked, an attacker has to deal with many system components where the security policy functions are mingled with all the other operations.

It is a substantial and technically difficult task to fortify a large or even a medium-sized software system. There are two systems involved in fortification. First is the fortified software being fortified and second is the system that creates the fortification. The fortified software is of course modified during the fortification process. In principle, fortified software can be created in many ways as long as the result is secure. In practice, it is much more efficient to use a systematic and deliberate approach to create fortified software unless the fortified software system is rather simple.

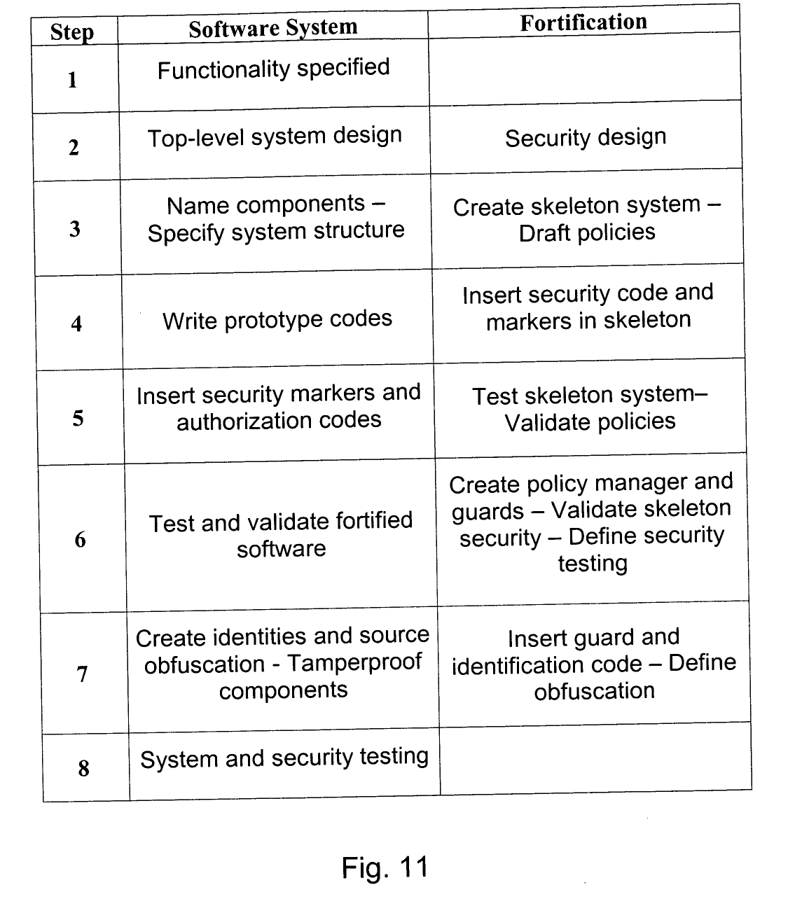

An outline of a systematic and deliberate approach is shown in FIG. 11 to illustrate a method of fortifying a large, complex system. The process illustrated in FIG. 11 shows the steps of the software development process aligned next to the corresponding steps of the fortification process. The fortification of the fortified software is planned and carried out in parallel with the development of the fortified software itself. The outline in FIG. 11 shows how an embodiment of this process could take place.

Steps 1 and 2 are standard in software development. In Step 1, the goals and methods of the software system are defined, and Step 2 is the beginning of the parallel design of the software system and the fortification.

Step 3 is where a skeleton version of the fortified software is created for use in the fortification design and development. It is at this point that some of the data protection policies are developed.

Step 4 includes two parallel actions: the prototype system code is written and a prototype security plan of Step 3 is implemented. It is in Step 4 that the security policies are put into the skeleton code.

In Step 5, the markers for the special security information and the actual special authorization code are inserted into the system. Simultaneously, in Step 5, the security policies are tested and validated using the prototype system code. This is where parts of security policies are transferred into the system code.

In Step 6, the system code is tested and validated. This includes the security authorization codes but not the other security items. In parallel, in Step 6, the policy manager and guards are created, the skeleton security is validated and the security testing is defined. The final structure of the fortified software is used to validate the security plan. Also in Step 6, special security items are implemented.

Step 7 is the integration of the system code with the security. In this step, the fortified software is implemented and the fortification is completed. Typical specific steps that are performed here include:

Source code obfuscation, if any.

Create and insert source code for identity creation and testing, if any.

Insert any policy manager code distributed into system components.

Compile source code.

Obfuscate machine code, hide data items identified by markers.

Tamperproof binary codes; create both internal guards and guards in one component that guard another. More obfuscation of machine code and hiding data items.

Compute data for external guards

Compile external guards and policy manager.

Tamperproof external guards, policy manager, etc.

Step 8 includes system and security tests and is when final acceptance tests for the fortified system are performed.

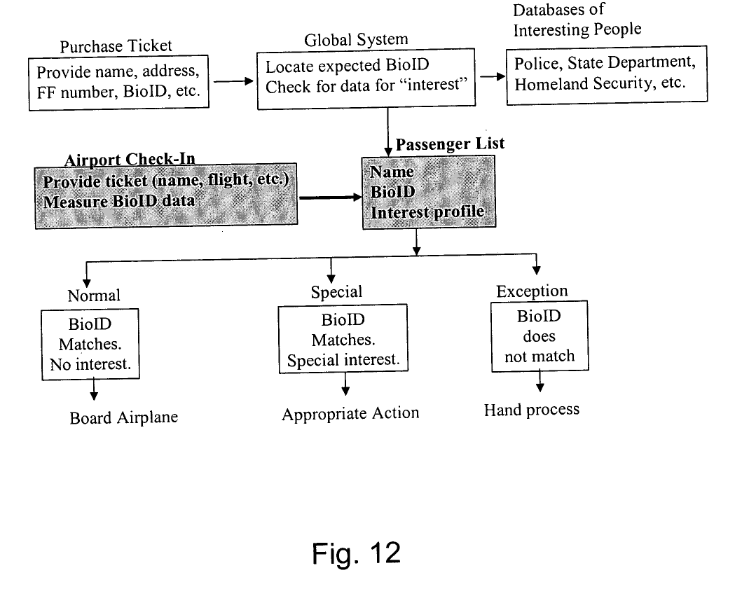

As an example, consider an airport passenger check-in system that identifies passengers, accesses existing ID databases and screens the passengers for potentially dangerous people. The system is to protect the privacy of individual data, not delay passengers unduly and to be secure against hacker attacks. The description is simplified here to concentrate on the “be secure against hacker attack” requirement. We assume that the biometric identification, called BioID, used is fingerprints. The basic requirements of the check-in procedure are:
Passenger's BioID is measured at check-in, verified against passenger list.
Passenger ticket contains usual information in machine readable form.
Quick BioID measurements and passenger processing.
High public acceptability and confidence. Identity theft, spoofing of system and similar unauthorized actions must be completely prevented.
   A diagram of the overall airline passenger management process at flight time check-in is shown in FIG. 12. The BioID can be a fingerprint, faceprint, retinal scan, signature and/or other biometric information.

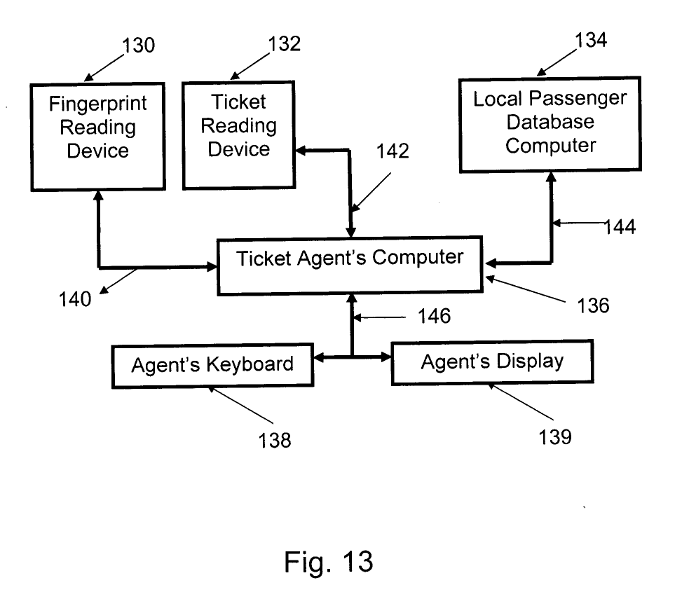

The components and interfaces of the counter check-in system are shown in FIG. 13. The check-in system at the airline counter shown in FIG. 13 has ten components, the six devices plus four connections, which must be guarded by the fortification. The six devices are a passenger fingerprint reader 130, a ticket reader 132, a ticket agent's computer 134, a keyboard 138 and display 139 for the agent's computer 134, a local passenger database system 134. The local passenger database system 134 interfaces with a global airline database system. The four interfaces are: a fingerprint reader interface 140 between the fingerprint reader 130 and the agent's computer 136, a ticket reader interface 142 between the ticket reader 132 and the agent's computer 136; a local database interface 144 between the local passenger database system 134 and the agent's computer 136; and the agent I/O interface 146 between the agent's computer 136 and the agent's keyboard 138 and display 139. There are two people involved in the check-in process, a passenger and an agent. The agent's computer 136 is the hub for the system. The global airline system is excluded for simplicity; it is connected to many other travel information systems (police, airport security, homeland security, selected airline, other airlines, banks . . . ).

There are three types of attacks that could compromise the security of this system. First is spying and spoofing for connections 140, 142, 144 and 146. Our assumption of a secure infrastructure means that spying is not a concern, the communication is secure. However, spoofing is a concern and we must assure that the devices connected are the correct devices. This is done using the secure identities and challenge-response identity verification procedures. Second is impersonation (by people or programs) at components 130, 132, 134, 136, 138, 139 or by an agent or a passenger. Again, secure identities are used to prevent this. However, some of these identities are not electronic so other means must be used, typical examples are:
Passenger. Identity is established by (a) fingerprint, (b) possession of ticket, and (c) corresponding entry in passenger list for the flight.
Agent. Identity is established by (a) fingerprint at log on time, (b) faceprint at random times during check-in (the display has a simple camera pointed at the agent), and/or (c) keystroke print taken when certain words are entered into the keyboard.
Hardware Devices. Identity is established by (a) serial numbers and (b) matching hardware (and software) configurations
   Finally, internal and external tamperproofing prevents any changes in the system's software components. The assumption of a secure infrastructure precludes physical tampering of the system components; in particular, all the device identifications are physically secure.

All of the system programs are tamperproofed as with the Arxan EnforcIT tool. This includes components 130-139. The tamperproofing creates a network of internal guards within each of these programs. When tampering is detected, the responses programmed into these components follow the policies set in the policy system. These responses, at least, notify the agent, the overall airline passenger management system and the local check-in system itself stops processing passengers until the supervisor restarts it. The internal guards in the fingerprint reader 132, the ticket reader 134 and the keyboard 138 and display 139 check codes, data, and machine IDs. These guards are in simpler computing environments and it is easier to identify the executable code. One must also ascertain exactly how the device serial numbers, and other identification information are accessed. The fingerprint reader 132, the ticket reader 134 and the agent's computer 136 have small internal memory files of IDs and relevant policies (installed by the fortification process).

The agent's computer 136 and the local passenger database 134 have internal guards to check themselves. In addition they act as external guards to check each other and components 130, 132, 138, 139 and the agent. They have substantial memory files of IDs and policies installed by the fortification process. They also have independent external guards.

The computers, components 134 and 136, have public IDs and are attached to various networks. All the devices have local private or shared IDs. The entities in the check-in system are listed along with their identifications of various types.
Passenger: Fingerprint (private to passengers and check-in system), name and address (public), possession of ticket (shared with airline system), photo ID drivers license (public)
Ticket: Key (shared with airline system, travel agents, passengers), passenger owner (shared with airline system), flight data (public).
Agent: Fingerprint (private to agent and airline system), keystroke-print (private to airline system), face-print (shared with airline system), photo ID (public), name and address (public)
Computers 134 and 136: Internet addresses (public), machine-prints (private to system), names (shared with airline system), names (private to check-in system)
Devices 130, 132, 138 and 139: Machine-prints (private to system), names (private to check-in system).
Connections 140, 142, 144 and 146: Names derived from the machines and devices they connect (private to end points of the connection), names (shared with check-in system).

Sample application, generic and authorization policies for this system are listed below. The components and connections are identified by the numbers in FIG. 13.

Application Specific
Passenger ID is always checked during communication across connections 140, 142, 144 and 146.
Ticket ID is always checked during communication between 142, 144 and 146.
Connection endpoints are always checked for use of 140, 142, 144 and 146.
The agent's ID is always checked during communication between 134 or 136 and the agent.
Codes in 130, 132, 136 and 138 are always checked by 134 before access.
Machine ID is always checked by components 130-138 at the start of execution.
There are five independent external guards in 134 and 136.
The integrity of all components is checked every 2 seconds (average) by 134 and 136.

Generic Protection
Elapsed execution time check at random (5 sec. average) by 130-139.
Execution frequency check every 0.5 seconds by 130-139.
Random sample execution with known results (5 sec. average) by 130-139.
Guard network checks itself every 10 seconds (average).
Clock check every 7 minutes by 130, 132, 136, 138 and 139.
Every code checks itself every time.
Virus checking occurs before each execution starts and then at random.

Authorization
The check-in system is authorized by the supervisor for a limited set of flights.
The agent must operate 136, 138 and 139. Only the supervisor can change this authorization.
The agent and 136 can jointly access/update database 134; and only for the authorized flight set. All updates are “signed” by the agent and 136.
The agent must launch work on 130, 132 and 136.
Devices 130, 132, 138 and 139 must be connected to 136. Only the supervisor can change this authorization.

Another example of a fortified system can be illustrated by an election voting system at a voting site. The fortified system must: (i) identify people: the voters and the staff (poll workers, party representatives and political authorities), (ii) access voter record databases, (iii) allow voting and (iv) collect the results. The system is to protect the privacy of individual data, not delay voters unduly and to be secure against hacker attacks. The description is simplified here to concentrate on the “be secure against hacker attack” requirement. We assume that the biometric identification, called BioID, used is face-prints and fingerprints. The basic requirements of the voting procedures are as follows:
High public acceptability and confidence.
Manipulation of results must be completely prevented.
Quick and easy voting.
Maintain a complete, secure audit record of the entire voting process.
Every voter is identified, certified and issued a token allowing a vote.
The identity of every staff person is verified at “check-in” against an authorized list. Further random identity checks are made.
The token is machine readable, unique and tied to the voter.

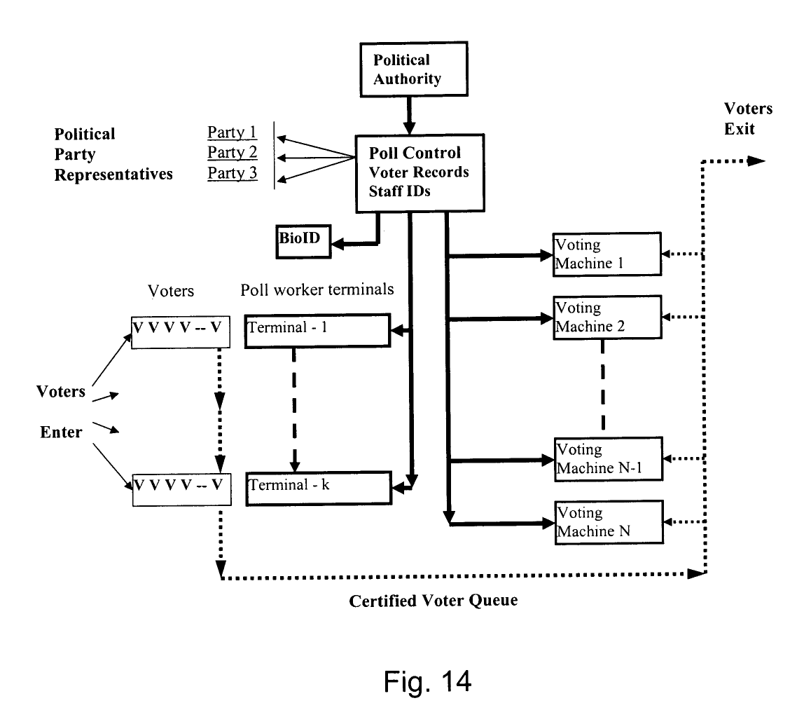

The structure of the overall voting system is illustrated in FIG. 14. The voting system at the polling place has eight types of components and various connections as shown in the Figure. The eight component types include: a poll control machine, terminals to certify voters, voting machines, a registered voter database, a staff ID database, a voting audit record, biometric identification devices (e.g., a fingerprint reader), and video cameras for use with the biometric identification devices. The poll control machine and terminals have video cameras for checking face-prints. The associated software system is to be fortified.

There are four types of people involved in this process: (1) political authority, the entity running the election; (2) party representatives, one for each party involved, running the voting site; (3) poll workers, one for each terminal of the system; and (4) voters. Only the political authority is fixed, the other staff may change during the voting but they all must be identified and registered in advance, and then be recognized and authorized as they assume their roles. They may come and go during the voting. Face-prints are checked from time to time for those using the poll control machine and terminals. The fortified system has no external network connections. Its software and databases are initialized in advance by the political authority using physical storage devices carried to the polling place. A complete audit record is kept of the events at the voting site. We assume these are secure to simplify the discussion.

There are many potential attack points in the voting system. The voting site system has the K+N+2 physical components seen in FIG. 14 plus all the connections which must also be guarded by the fortification. There are three types of attacks that could compromise the security of this system. First is spying and spoofing in the connections. The assumption of a secure infrastructure means that spying is not a concern; the communication is secure. However, spoofing is a concern and we must assure that the actual devices connected are the specified devices. This is done using the secure identities and challenge-response identity verification procedures. The second is impersonation (by people or programs) within the system. Again, secure identities are used to prevent this. However, some of these identities are not electronic so other means must be used, typical examples are:
Voters. Identity is established by (a) some physical document and (b) corresponding entry in the voter records.
Staff. Identity is established by (a) fingerprint at log on time and (b) faceprint at random times during machine/terminal use (they have a camera pointed at the user).
Hardware. Identity is established by (a) serial numbers and (b) matching hardware (and software) configurations
   Third, people with access to the machines could tamper with the programs and data. Internal and external tamperproofing guards prevent any changes in the fortified system. The voter records and staff IDs are read-only data and encrypted (except when being used). The assumption of a secure infrastructure precludes physical tampering of the system components; in particular, all the hardware (machines, terminals, BioID devices) identifications are physically secure. Note that it is beneficial to have a “minimal” operating and generic support system on all the machines. This reduces the number of possible “weak points” in the generic software. It is also beneficial to use a “rarely used” system which is not so likely to have been studied for security weaknesses by attackers.

All programs in fortified system are tamperproofed as with the Arxan EnforcIT tool. This includes the poll control, terminals, voting machines and BioID devices. The tamperproofing creates a network of internal guards within each of these programs. When tampering is detected, the responses programmed into these components follow the policies set in the policy system. These responses, at least, notify the party representatives, create an entry in the voting audit record, and the voting site system itself stops processing voters until the party representatives restart it. The internal guards in all components, except BioID devices, check codes, data, and machine IDs. All these machines have internal memory files of hardware identification information and relevant policies (installed during the fortification process). In addition, the poll control machine contains external guards to check all the other components. It has a memory file of identification information and policies installed during the fortification process. The terminals have external guards that protect the poll control machine software.

The computers have public IDs. All the devices have local private or shared IDs. The entities in the voting site system are listed below along with their various types of identifications.
Voters: Determined by the political authority; could include name, address (public) and photo ID (public). After they have been verified, they are issued a token that is used as the ID at the voting machines.
Token: Key or ID number (shared throughout the system).
Staff and Political Authority: Fingerprint (private to person and system), face-print (shared with voting site system), photo ID (public), name and address (public)
Computers and terminals: Network addresses (private to system), machine-prints (private to system), pseudonyms (shared with system), names (public)
Connections: Names derived from the machines and devices they connect (private to end points of the connection), pseudonyms (shared with voting site system).

Application, generic and authorization policies used for the fortified system are listed below. When a time interval is given for checking, it means an average value. Actual values are preferably varied randomly within about twenty percent of this average. The generic word “machines” includes the poll control, the terminals and the voting machines.

Application Specific
Political authority and staff IDs are always checked during communication between machines.
Hardware ID is always checked during communication between machines/devices.
Connection endpoints are always checked.
The voter's ID is always checked at the check-in terminal.
Codes in machines and BioID are always checked by the poll control machine before access.
Machine IDs are always checked at the start of execution.
The poll control machine has a network of external code guards as follows: ten for itself, four for each voting machine, two for each terminal and five for the external guards themselves.
The integrity of all components is checked every 2 seconds by the external guards.

Generic Protection
Elapsed execution time check every 5 seconds by all machines.
Execution frequency check every 0.5 seconds by all machines.
Random sample execution with known results every 5 seconds by all machines.
External guard network checks itself every 10 seconds.
Clock check every 7 minutes by poll control and voting machines.
Every code checks itself at all times.

Authorization
System is authorized by the political authority for set up and to start voting.
Party representatives can operate the poll control. Only the political authority can change this authorization or the identity of the representatives.
Political authority and party representatives can jointly read the audit record. This authority is for disputes, equipment failures, attack alarms and other emergencies. This action becomes part of the audit record and the record cannot be modified.
A BioID device, at least one terminal and at least one voting machine must be connected to poll control machine at all times.
Party representatives can jointly launch or turn-off terminals and voter machines.
Party representatives can jointly authorize changes in the terminal staff.
Tokens are “signed” by the staff person at the terminal.

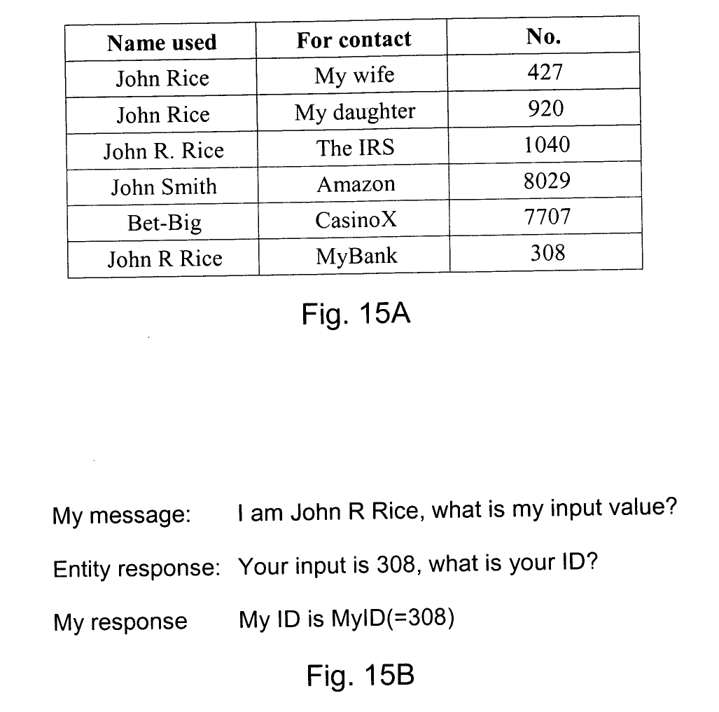

As an example of the use of multiple IDs, consider a function MyID(Input) where the value computed is not related to Input in any predictable way. MyID could, for example, just look up numbers from a table of 10,000 numbers (they need not even be different). Identities with different names for different contacts are generated and given a key (password) for them to verify my identity. A table as shown in FIG. 15A is maintained with the name used for each contact along with the associated input. When I first establish a relationship with a contact, say MyBank, I give my name used, contact input and MyID(input) and simultaneously record the value of input used. Thus, when establishing a relationship with MyBank, a new entry is made in the table of John R Rice—MyBank—308.

When I contact MyBank the exchange is as shown in FIG. 15B. First, I send a message to MyBank and request my input value to ensure that I am connected with MyBank. MyBank returns the input value 308 and requests my identification information. I then respond with my identification information which uses the function MyID. At this point I have established that I am actually talking to the bank and the bank has established that I am John R Rice. If I am already certain that I am talking to the bank, the request for Input could be skipped. Note that secure communication is assumed here.

This approach is made highly secure by increasing the complexity of MyID and the protocols for exchange of information. MyID could use a 12 digit input and produce four values, each with 12 digits. This provides 10³⁶ potential ID values and 10¹² possible names; with only 10¹² inputs to MyID there can actually be only 10¹² different outputs. If there is no predictable relationship between the input and the ID values, then a secure ID exists. A wide variety of communication applications can be made secure using this technology.

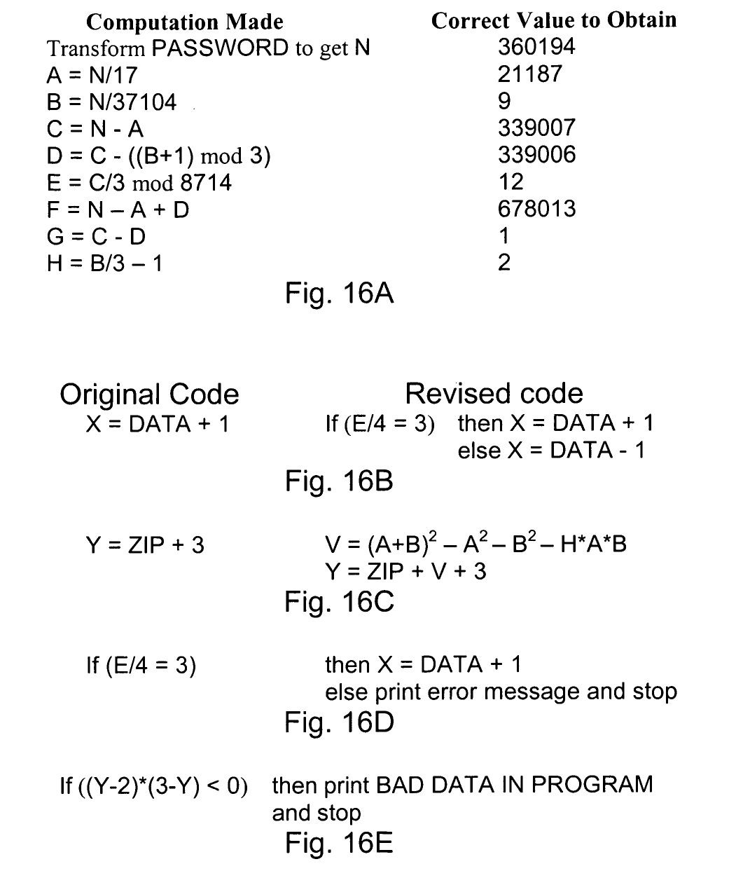

As example of hiding and protecting data is described with reference to FIG. 16. Suppose the string 0a+ is the true password. This string is converted to the number 360194 by the usual alphanumeric encoding of character strings. Then the PASSWORD string presented externally is processed as shown in FIG. 16A. Next, we use both a direct and a silent guard to test the correctness of PASSWORD.

First, a simple statement in the software is randomly selected, say X=DATA+1, is replaced with the statements shown in FIG. 16B. Then another statement is randomly selected, say Y=ZIP+3, and replaced with the statements shown in FIG. 16C: It is easily seen that X and Y are computed correctly provided that E=12 and H=2. Thus, if the password provided is correct then the computation of X and Y remains correct.

The test could be even more explicit such as shown in FIG. 16D. The silent test can be later transformed into an explicit test. For example, suppose that the variable X is used in the computation of Y and it is known that Y is always between 2 and 3. Then one can insert the statement shown in FIG. 16E to test the password:

Note that neither the number 360194 nor the string 0a+ appears anywhere in the resulting software. Of course, this simple example does not hide 0a+ very well, but one can extend this approach extensively and then obfuscate the resulting code to make it very difficult to determine the correct password from the information in the software.

Data can be protected from tampering by using both internal and external guards. External guards provide stronger protection because they are harder to find and their anti-tamper actions are not synchronized with the execution of the program containing the data. Micro guards are useful to provide special protection to particularly important data items. Micro guards are very short guards (1 or 2 statements) which check one “item” in a program. They are very hard to detect and execute very fast, which makes them very well suited for use in external virus guards.

Special guards can be used to protect against viruses, dynamic attacks and clone attacks. There is a class of attacks that involves inserting malware into code at the very beginning (or elsewhere). Special guards are needed which focus on the common properties of these attacks. The basic steps in these protections are as follows
Start of program. Guard the first few instructions. This guard should go as close to the start of the program as practical.
Program exits and calls to other programs. Check for modifications at points where the program exits or transfers control. Changes here probably reflect dynamic and clone attacks. These virus guards should be as close to the exits as practical. These locations could also be checked at other places in the program.
Empty space in the program. Guard all these spaces. Viruses and dynamic/clone attackers usually place new code at the end of the program. But, an attacker can analyze a program and identify empty spaces with data structures, between code components, etc. This space can be used in lieu of the empty space at the end of the program for attacks. More than one guard should be used; at least one very early in the program and one near the end. Others can be placed in the program.
   Such guards should be networked together so as to provide very strong protection against dynamic attacks, viruses and related malware.

The goal of virus guards is to protect against viruses being inserted into a program. Internal virus guards do exactly the things described above. External virus guards can also check the start, transfer points plus other empty spaces. External virus guards provide additional protection because the guarding is not synchronized with the program's execution. In particular, they are able to check the initial statements of P before they execute to initiate a virus attack. A network of guards can be created that makes these checks both before and after the program executes and at random times during the program's execution. Thus, providing complete virus protection. Virus guards can also provide much better defenses against dynamic and clone attacks which involve inserting “virus-like” code into the program.

A dynamic attack against a program P proceeds as follows. One finds a spot S#1 in P that is not checked before it executes [the first statement always qualifies]. Copy S#1's code to empty space and insert new code which makes step #1 of the attack. Then locate spot S#2 which is not checked between the time S#1 is executed and S#2 is reached. Copy S#2's code to empty space and insert new code which makes step #2 of the attack. This chain is continued until the attack is complete. The final step may include erasing all the codes inserted and restoring the original code to remove the evidence of the attack. The original code may be restored step by step also. The dynamic attack is always “on the move” to avoid detection. At some crucial time the attack's action is taken. Such an attack can be used to steal $10 million from Mr. X's bank account. The attack starts after the bank's system has identified Mr. X making a transaction, e.g., an ATM withdrawal. The system is hijacked to (a) send $10 million to a safe offshore account, (b) update all records to show Mr. X authorized the transfer, (c) continue with the ATM withdrawal, and (d) erase all traces of the attack. Such attacks appear complex at first, but following the details of one makes it easy to see how to do it in general.

An external guard can check all the empty spots in program P to detect the code that such an attack uses. Further, the external guard's checking of P's code is not synchronized with the execution of P so that the attacker is unable to avoid detection by being always “on the move” away from the guarding. A dynamic attack on a well tamper-proofed (by internal guards) program is very difficult. One must identify the guards and other protections of program P in detail and then devise a strategy to move code around to avoid detection. Nevertheless, a dynamic attacker can probably succeed no matter how well P is protected by internal guards (including silent, repair and other types of internal guards). Using external virus guards makes it easy (and relatively cheap) to prevent dynamic attacks. A successful dynamic attacker must defeat both the internal and external guarding.

A clone attack on the code P operates as follows:
1. Copy the code of P to another part of memory creating code Q.
2. Modify code Q as desired. Note that the checksum guards in Q still check the statements of P, not Q, as they operate on addresses relative to the base address of P.
3. Modify statement 1 of P to jump to statement 1 of Q and let the modified code Q execute. When it is done, (i) repair statement 1 of the code P, (ii) erase as much as possible of Q, (iii) jump to statement 1 of P and let P execute.
   Alternatively, at step 3, one could terminate the execution of P “normally” instead of letting P execute again. This is more difficult (one must understand P much better) but might be necessary for some programs.

An external guard normally cannot locate the program Q but it can observe that statement 1 of program P is wrong. Thus, a virus guard can detect a clone attack and take appropriate action. Note that the guard must check P rather often; the checking interval should be substantially less than the time to execute P. The clone attack can also be detected by the fact that many variables in program P are changing while program Q executes and an external guard can check these.

Anti-cloning guards are repair guards used in a special way to defend against clone attacks. Early in the program repair guards are inserted that correct deliberate errors in code executed later. These corrections take place in the program P and not in the program copy Q. As a result, the cloned code has errors and does not execute properly. To help hide the guard, the code can be re-damaged later so the repair is not revealed by a postmortem dump. Note that silent guards are also anti-cloning guards as their protection is unaffected by cloning.

While the invention has been illustrated and described in detail in the drawings and foregoing description, such illustration and description is to be considered as exemplary and not restrictive in character, it being understood that only exemplary embodiments have been shown and described and that all changes and modifications that come within the spirit of the invention and the attached claims are desired to be protected.

I claim:

1. Method of protecting a protected program performed by an external guard, the external guard not being part of the protected program, the method comprising:
selecting a first code segment of the protected program;
computing a true checksum value for the first code segment;
storing the true checksum value to be accessed by the external guard;
under control of the external guard;
locating the protected program;
reading a second code segment of the protected program, the second code segment including the first code segment,
computing a computed checksum of the first code segment;
comparing the computed checksum with the true checksum value; and
taking protective action based on the result of the comparison.

2. Method of protecting a protected program performed by an external guard, the external guard not being part of the protected program, the method comprising:
selecting a first code segment of the protected program;
computing a true checksum value for the first code segment;
storing the true checksum value;
computing a computed checksum of the first code segment;
storing the computed checksum;
comparing the computed checksum with the true checksum value by the external guard; and
taking protective action based on the result of the comparison.

3. The method claim 2, further comprising:
calling the protected program by the external guard; and
returning the computed checksum to the external guard as an argument.

4. The method claim 2, wherein the step of storing the computed checksum includes:
posting the computed checksum to a bulletin board.

5. The method claim 2, further comprising:
computing a first variable;
computing a disguised form of the true checksum value using the first variable;
storing the true checksum value in its disguised form;
making the first variable accessible to the protected program; and
computing a disguised form of the computed checksum using the first variable; and wherein
the step of storing the true checksum value is performed by storing the disguised form of the true checksum value;
the step of storing the computed checksum is performed by storing the disguised form of the computed checksum; and
the comparing step is performed by comparing the disguised form of the computed checksum with the disguised form of the true checksum value by the external guard.

6. The method claim 5, further comprising:
returning the disguised form of the computed checksum to the external guard as an argument: and wherein
the making step is performed by passing the first variable to the protected program as an argument; and.

7. The method claim 5, wherein the step of storing the computed checksum includes:
posting the disguised form of the computed checksum to a bulletin board.

8. The method claim 7, wherein the step of making the first variable accessible to the protected program includes:
posting the first variable to a bulletin board.

9. The method claim 2, wherein the taking protective action step includes:
performing one of activating an alarm and notifying security personnel.

10. The method claim 2, wherein the taking protective action step includes:
corrupting program execution.

11. Method of protecting a protected program performed by a plurality of external guards, each of the plurality of external guards not being part of the protected program, the method comprising:
under control of the plurality of external guards;
checking the first few instructions of the protected program;
checking the end of the protected program;
checking the empty spaces of the protected program;
taking protective action based on the result of the checking steps.

12. The method claim 11, further comprising:
under control of the external guard;
checking the locations where the protected program transfers control.

13. The method claim 11, wherein at least one of the checking steps is performed by at least one of the plurality of external guards prior to execution of the protected program.

14. The method claim 11, wherein at least one of the checking steps is performed by at least one of the plurality of external guards during execution of the protected program.

15. The method claim 11, wherein at least one of the checking steps is performed by at least one of the plurality of external guards after execution of the protected program.

16. The method claim 11, wherein each of the plurality of external guards are micro-guards.

17. The method claim 11, further comprising:
under control of the plurality of external guards;
detecting execution of the protected program;
detecting change in variables of the protected program
checking for changes in variables of the protected program when the protected program is not executing;
taking protective action based on the result of the step of checking for changes in variables of the protected program when the protected program is not executing.

18. Method of protecting a protected program performed by an external guard, the external guard not being part of the protected program, the method comprising:
selecting an input variable of the protected program having an expected value;
creating a new variable that is dependent on the input variable;
revising an instruction to make it dependent on the new variable, whereby the instruction will evaluate correctly if the input variable has the expected value and will evaluate incorrectly otherwise;
under control of the external guard;
obtaining the entered value of the input variable entered during execution of the protected program;
computing the value of the new variable using the entered value of the input variable; and
executing the instruction using the value of the new variable computed using the entered value of the input variable.

19. Method of identifying a program using a signature, the method comprising:
storing an identification data list containing identification items and indices for the identification items;
randomly selecting a first set of identification items from the identification data list;
storing the indices of the first set of identification items in the identification data list;
creating a first signature from the pairs of index, identification item for the first set of identification items;
registering the first signature of the first program with a second program;
checking the first signature by the second program during contact between the first program and the second program.

20. The method of claim 19, wherein the identification items are the instructions of the first program.

21. The method of claim 19, further comprising:
randomly selecting a second set of identification items from the identification data list;
storing the indices of the second set of identification items in the identification data list;
creating a second signature from the pairs of index, identification item for the second set of identification items;
registering the second signature of the second program with the first program;
checking the signature of the second program by the first program during contact between the first program and the second program.

22. Method of identifying a program using random number generators, the method comprising:
using a first random number generator capable of generating a first set of random numbers;
using a number from the first set of random numbers as a seed for a second random number generator; and
creating a signature using the second random number generator with the seed generated by the first random number generator.

23. The method of claim 22, further comprising:
establishing a function that can accept a number from the first set of random numbers as input;
computing a parameter using the function with an unused number from the first set of random numbers as input; and
creating a signature using the second random number generator with the parameter generated by the function, the second random number generator having a dependency on the parameter and the seed.

24. The method claim 22, further comprising:
using a plurality of additional random number generators to generate random numbers using different numbers from the first set of random numbers as seeds for each of the plurality of additional random number generators; and
creating a signature as a function of the random numbers generated by the second random number generator and the plurality of additional random number generators.

25. A method of developing fortified software comprising:
performing a security design for the fortified software;
creating a skeleton version of the fortified software for security analysis;
drafting security policies for the fortified software;
implementing the security code in the skeleton version of the fortified software;
testing the skeleton version of the fortified software to validate the security policies;
creating a system policy manager for the fortified software;
determining guards to be used in the fortified software;
inserting code for guards and identification in the fortified software; and
defining obfuscations to be used in the fortified software.

26. The method of claim 25, further comprising:
specifying the system structure of the fortified software;
writing prototype code for the fortified software;
inserting security markers in the fortified software;
inserting authorization codes in the fortified software;
creating identities for use in the fortified software;
obfuscating the fortified software;
tamperproofing the components of the fortified software; and
performing final system and security tests on the fortified software.
